(19) United States
(12) Patent Application Publication
(10) Pub. No.: US 2025/0056581 A1
(43) Pub. Date: Feb. 13, 2025

(54) TECHNIQUES FOR JOINT COMMUNICATION AND SENSING USING GUARD SYMBOLS IN SIDELINK

(71) Applicant: QUALCOMM Incorporated, San Diego, CA (US)

(72) Inventors: Kangqi LIU, San Diego, CA (US); Weimin DUAN, San Diego, CA (US)

(21) Appl. No.: 18/366,524

(22) Filed: Aug. 7, 2023

(51) Int. Cl. H04W 72/40; H04W 72/1263; H04W 72/21; H04W 72/25; H04W 72/51

(52) U.S. Cl. CPC H04W 72/40; H04W 72/1263; H04W 72/21; H04W 72/25; H04W 72/51

(57) ABSTRACT

Disclosed are techniques for wireless communication. In an aspect, a sidelink device may receive a configuration indicating one or more sidelink resource pools. The sidelink device may receive a request to report a radio frequency (RF) capability. The sidelink device may transmit, responsive to the request, an RF capability type of the sidelink device. The sidelink device may receive a sidelink allocation indicating a set of sidelink resources from the one or more sidelink resource pools and indicating one or more sidelink communication resources, one or more sidelink sensing resources, or both associated with the set of sidelink resources. In an aspect, the sidelink allocation may be based on the RF capability type of the sidelink device.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a sidelink device includes receiving a configuration indicating one or more sidelink resource pools; receiving a request to report a radio frequency (RF) capability; transmitting, responsive to the request, an RF capability type of the sidelink device; and receiving a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

In some aspects, the sidelink allocation comprises the one or more sidelink communication resources absent any indication of a sidelink sensing resource based at least in part on the RF capability type of the sidelink device being a communication-only type.

In some aspects, the sidelink allocation comprises the one or more sidelink sensing resources absent any indication of a sidelink communication resource based at least in part on the RF capability type of the sidelink device being a sensing-only type; and the one or more sidelink sensing resources comprise a last symbol of sidelink slot.

In some aspects, the sidelink allocation comprises the one or more sidelink communication resources and the one or more sidelink sensing resources based at least in part on the RF capability type of the sidelink device being a joint communication and sensing type; and the one or more sidelink sensing resources comprise one or more guard periods associated with the one or more sidelink communication resources.

In some aspects, the method includes transmitting a communication scheduling request and a sensing scheduling request in a first uplink control information (UCI) via a first physical uplink control channel (PUCCH).

In some aspects, the method includes encoding a communication scheduling request in a first uplink control information (UCI); encoding a sensing scheduling request in a second UCI different from the first UCI; transmitting the first UCI via a first physical uplink control channel (PUCCH); and transmitting the second UCI via a second PUCCH.

In some aspects, the sidelink allocation is received as a downlink control information (DCI) via a physical downlink control channel (PDCCH).

In some aspects, the sidelink allocation is received as a first downlink control information (DCI) via a first physical downlink control channel (PDCCH) and a second DCI via a second PDCCH different from the first PDCCH.

In an aspect, a method of wireless communication performed by a first sidelink device includes receiving a configuration indicating one or more sidelink resource pools; and transmitting, to a second sidelink device, sidelink control information (SCI) comprising a sidelink allocation indicating a set of sidelink resources from the one or more sidelink resource pools and indicating one or more sidelink sensing resources associated with the set of sidelink resources.

In some aspects, the one or more sidelink resource pools comprise a sidelink sensing resource pool or a joint sidelink communication and sensing resource pool.

In some aspects, the method includes receiving, from a network entity, an indication that a last symbol of a sidelink slot is configured to be reserved by the first sidelink device as the one or more sidelink sensing resources.

In some aspects, the method includes determining that the one or more sidelink sensing resources are to be used for bistatic sensing; and formatting, based at least in part on the determining, the SCI format to include control information of a sensing waveform associated with the one or more sidelink sensing resources.

In some aspects, the sidelink allocation indicates one or more sidelink communication resources associated with the set of sidelink resources.

In some aspects, the SCI comprises a semi-persistent scheduling of the one or more sidelink communication resources and a semi-persistent scheduling of the one or more sidelink communication resources; or the SCI comprises a dynamic scheduling of the one or more sidelink communication resources and the semi-persistent scheduling of the one or more sidelink communication resources.

In some aspects, the SCI comprises an indication of a sensing procedure associated with the one or more sidelink sensing resources.

In some aspects, the method includes performing a monostatic sensing procedure; and transmitting, to a network entity, a report associated with the monostatic sensing procedure.

In some aspects, the method includes performing a bistatic sensing procedure cooperative with the second sidelink device, and wherein the SCI comprises an indication for the second sidelink device to transmit a report associated with the bistatic sensing procedure to at least one of a network entity or the first sidelink device.

In some aspects, the method includes performing a monostatic sensing procedure and a bistatic sensing procedure cooperative with the second sidelink device.

In some aspects, the SCI comprises an indication for the second sidelink device to transmit a first report associated with the bistatic sensing procedure to the first sidelink device, and the method further comprising: receiving the first report associated with the bistatic sensing procedure; combining a second report associated with the monostatic sensing procedure with the first report associated with the bistatic sensing procedure; and transmitting, to a network entity, a combined report associated with the monostatic sensing procedure and the bistatic sensing procedure.

In some aspects, the method includes transmitting a report associated with the monostatic sensing procedure to the second sidelink device, and wherein the SCI comprises an indication for the second sidelink device to transmit a combined report associated with the monostatic sensing procedure and the bistatic sensing procedure.

In an aspect, a method of wireless communication performed by a first sidelink device includes receiving a configuration indicating one or more sidelink resource pools; receiving, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and processing the SCI based at least in part on a radio frequency (RF) capability type of the first sidelink device.

In some aspects, the sidelink allocation comprises the one or more sidelink sensing resources, and the method further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink sensing resources.

In some aspects, the sidelink allocation comprises the one or more sidelink communication resources.

In some aspects, the method includes refraining, based at least in part on the RF capability type of the first sidelink device being a sensing-only type, from transmitting SCI for reserving sidelink sensing resources in the set of sidelink resources; and refraining, based at least in part on the RF capability type of the first sidelink device being the sensing-only type, from monitoring signals corresponding to the one or more sidelink communication resources.

In some aspects, the method includes refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink communication resources.

In some aspects, the sidelink allocation comprises the one or more sidelink communication resources and the one or more sidelink sensing resources, and the method further comprising: refraining, based at least in part on the RF capability type of the first sidelink device being a joint communication and sensing type, from transmitting SCI for reserving sidelink resources in the set of sidelink resources; monitoring, via a first set of RF components and based at least in part on the RF capability type of the first sidelink device being the joint communication and sensing type, signals corresponding to the one or more sidelink communication resources; and monitoring, via a second set of RF components different from the first set of RF components and based at least in part on the RF capability type of the first sidelink device being the joint communication and sensing type, signals corresponding to the one or more sidelink sensing resources.

In some aspects, the SCI comprises a first indication of a bistatic sensing procedure associated with the one or more sidelink sensing resources; and the SCI comprises a second indication for the first sidelink device to transmit a report associated with the bistatic sensing procedure to at least one of a network entity or the second sidelink device, and the method further comprising performing, based at least in part on the first indication in the SCI, the bistatic sensing procedure cooperative with the second sidelink device, and transmitting, based at least in part on the second indication in the SCI, the report associated with the bistatic sensing procedure.

In some aspects, the SCI comprises a first indication of a monostatic sensing procedure and a bistatic sensing procedure associated with the one or more sidelink sensing resources; and the SCI comprises a second indication for the first sidelink device to transmit a combined report associated with the monostatic sensing procedure and the bistatic sensing procedure, and the method further comprising performing, based at least in part on the first indication in the SCI, the bistatic sensing procedure cooperative with the second sidelink device, receiving, from the second sidelink device, a report associated with the monostatic sensing procedure, combining the report associated with the monostatic sensing procedure and a report associated with the bistatic sensing procedure, and transmitting, based at least in part on the second indication in the SCI, the combined report associated with the monostatic sensing procedure and the bistatic sensing procedure.

In an aspect, a sidelink device includes one or more memories; one or more transceivers; and one or more processors communicatively coupled to the one or more memories and the one or more transceivers, the one or more processors, either alone or in combination, configured to: receive, via the one or more transceivers, a configuration indicating one or more sidelink resource pools; receive, via the one or more transceivers, a request to report a radio frequency (RF) capability; transmit, via the one or more transceivers, responsive to the request, an RF capability type of the sidelink device; and receive, via the one or more transceivers, a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

In an aspect, a first sidelink device includes one or more memories; one or more transceivers; and one or more processors communicatively coupled to the one or more memories and the one or more transceivers, the one or more processors, either alone or in combination, configured to: receive, via the one or more transceivers, a configuration indicating one or more sidelink resource pools; and transmit, via the one or more transceivers, to a second sidelink device, sidelink control information (SCI) comprising a sidelink allocation indicating a set of sidelink resources from the one or more sidelink resource pools and indicating one or more sidelink sensing resources associated with the set of sidelink resources.

In an aspect, a first sidelink device includes one or more memories; one or more transceivers; and one or more processors communicatively coupled to the one or more memories and the one or more transceivers, the one or more processors, either alone or in combination, configured to: receive, via the one or more transceivers, a configuration indicating one or more sidelink resource pools; receive, via the one or more transceivers and from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and process the SCI based at least in part on a radio frequency (RF) capability type of the first sidelink device.

In an aspect, a sidelink device includes means for receiving a configuration indicating one or more sidelink resource pools; means for receiving a request to report a radio frequency (RF) capability; means for transmitting, responsive to the request, an RF capability type of the sidelink device; and means for receiving a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

In an aspect, a first sidelink device includes means for receiving a configuration indicating one or more sidelink resource pools; and means for transmitting, to a second sidelink device, sidelink control information (SCI) comprising a sidelink allocation indicating a set of sidelink resources from the one or more sidelink resource pools and indicating one or more sidelink sensing resources associated with the set of sidelink resources.

In an aspect, a first sidelink device includes means for receiving a configuration indicating one or more sidelink resource pools; means for receiving, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and means for processing the SCI based at least in part on a radio frequency (RF) capability type of the first sidelink device.

In an aspect, a non-transitory computer-readable medium stores computer-executable instructions that, when executed by a sidelink device, cause the sidelink device to: receive a configuration indicating one or more sidelink resource pools; receive a request to report a radio frequency (RF) capability; transmit, responsive to the request, an RF capability type of the sidelink device; and receive a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

In an aspect, a non-transitory computer-readable medium stores computer-executable instructions that, when executed by a first sidelink device, cause the first sidelink device to: receive a configuration indicating one or more sidelink resource pools; and transmit, to a second sidelink device, sidelink control information (SCI) comprising a sidelink allocation indicating a set of sidelink resources from the one or more sidelink resource pools and indicating one or more sidelink sensing resources associated with the set of sidelink resources.

In an aspect, a non-transitory computer-readable medium stores computer-executable instructions that, when executed by a first sidelink device, cause the first sidelink device to: receive a configuration indicating one or more sidelink resource pools; receive, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and process the SCI based at least in part on a radio frequency (RF) capability type of the first sidelink device.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 3D illustrates an example of a wireless communications system that supports unicast sidelink establishment, according to aspects of the disclosure.

FIG. 4 illustrates the two resource allocation modes for transmissions on a sidelink, according to aspects of the disclosure.

FIGS. 5A and 5B illustrate various scenarios of interest for sidelink-only or joint Uu and sidelink positioning, according to aspects of the disclosure.

FIGS. 6A and 6B are diagrams of example sidelink slot structures with and without feedback resources, according to aspects of the disclosure.

FIG. 7 is a diagram showing how a shared channel (SCH) is established on a sidelink between two or more UEs, according to aspects of the disclosure.

FIG. 8 is a diagram illustrating an example of a resource pool for positioning configured within a sidelink resource pool for communication, according to aspects of the disclosure.

FIGS. 9A and 9B illustrate different types of radar, according to aspects of the disclosure.

FIG. 10 illustrates a first example of a joint communication and sensing (JCS) system, according to aspects of the disclosure.

FIG. 11 illustrates a second example of a JCS system, according to aspects of the disclosure.

FIGS. 12A, 12B, and 12C illustrate examples of sidelink communication information (SCI), according to aspects of the disclosure.

FIGS. 13 to 15 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to techniques for joint communication and sensing operations. Some aspects more specifically relate to leveraging guard periods or symbols in sidelink communication for sensing purposes. That is, for example, guard periods or symbols may be included in a transmission slot for sidelink communication. These guard periods or symbols may enable timing adjustments for a device and/or allow the device to switch between transmission and reception. Some devices may be equipped with multiple sets of radio frequency (RF) components. Each set of RF components may be configured for various transmission and reception purposes. For example, a device may include a first set of RF components for communication purposes and a second set of RF components for sensing purposes.

In some examples, techniques for sidelink communication are described that consider an RF capability type of user equipment (UE) that is involved in various sidelink communication scenarios. In some examples, techniques for sidelink communication are described for allocation of joint communication and sensing resources by a network entity or a UE. In some examples, the behavior when a UE receives control information during sidelink communication is described. That is, for example, a UE may receive a downlink control information (DCI) or a sidelink control information (SCI) that provides control information to be used during sidelink communication. Based on the RF capability type of the UE, the UE behavior may vary when receiving the DCI or SCI. In some examples, the behavior when a UE transmits an SCI during sidelink communication is described. That is, for example, based on the on the RF capability type of the UE that is transmitting the SCI, the UE may vary the way sidelink resources are reserved and/or may include information related to sensing operations to be performed. In some examples, techniques for sidelink communication are described that consider a type of sensing operation that is involved in various sidelink communication scenarios. That is, for example, the UE behavior may vary depending on whether the type of sensing operation is a monostatic sensing procedure or a bistatic sensing procedure.

Particular aspects of the subject matter described in this disclosure can be implemented to realize one or more of the following potential advantages. In some examples, by leveraging guard periods or symbols in sidelink communication for sensing purposes and simultaneously performing wireless communication and sensing operations, the described techniques can be used to provide a cost-efficient deployment for wireless communication systems that involve both communication and radar operations. As the bandwidth allocated for wireless communication systems increases and more use cases and services evolve, joint communication and sensing techniques can enable efficient use of the allocated bandwidth. For example, radar techniques may include sending probing signals to uncooperative targets in a wireless communication system. The signal echoes from the uncooperative targets include useful information that may be inferred and applied to various services and operations of the wireless communication system. Additionally, or alternatively, information exchanged between two or more cooperative devices may be enhanced by determining positions of the uncooperative targets within the wireless communication system. That is, for example, by including information related to sensing operations to be performed in a transmitted SCI, a position of the uncooperative targets may be precisely and effectively determined.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (or UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

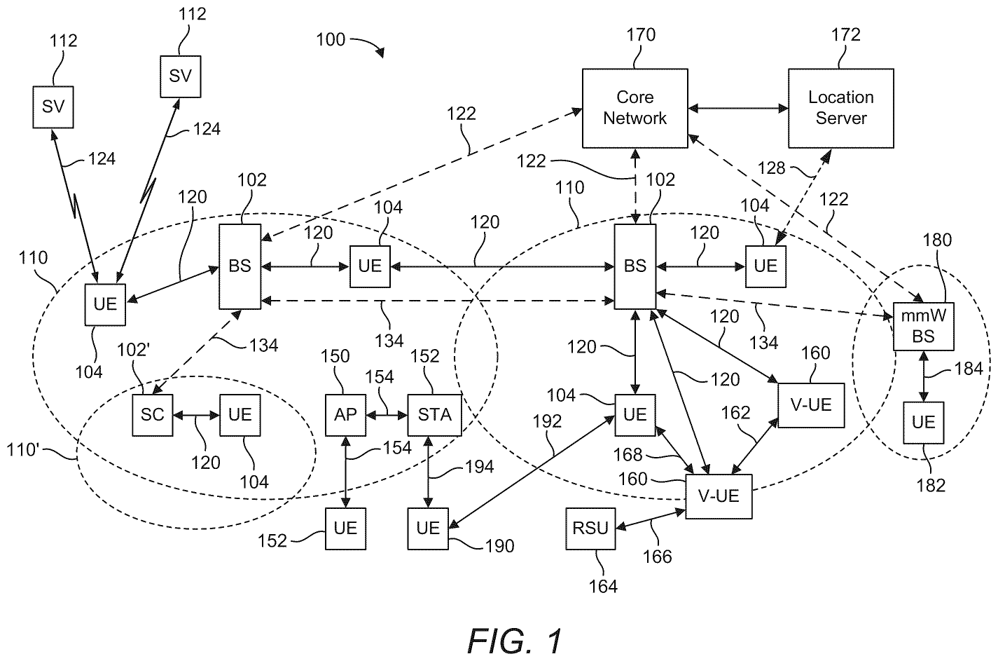

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing. V2V communication, V2X communication (e.g., cellular V2X (cV2X) communication, enhanced V2X (cV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHZ. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe, IEEE 802.11p operates in the ITS G5A band (5.875-5.905 MHZ). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHZ) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

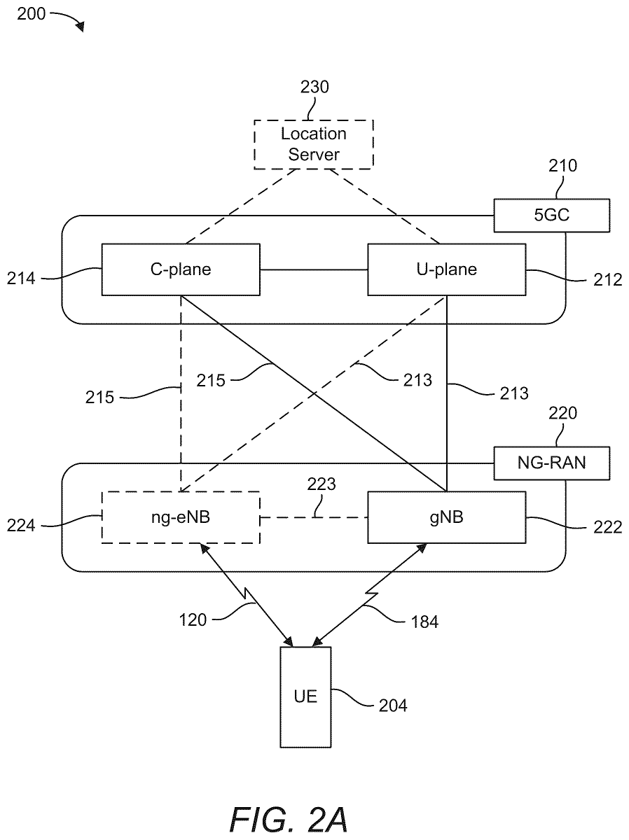

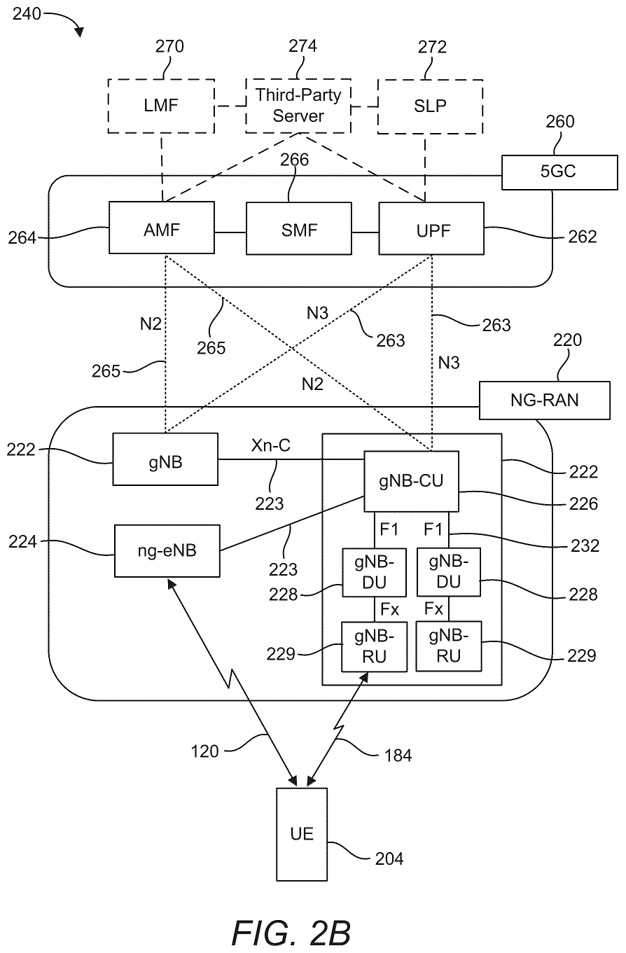

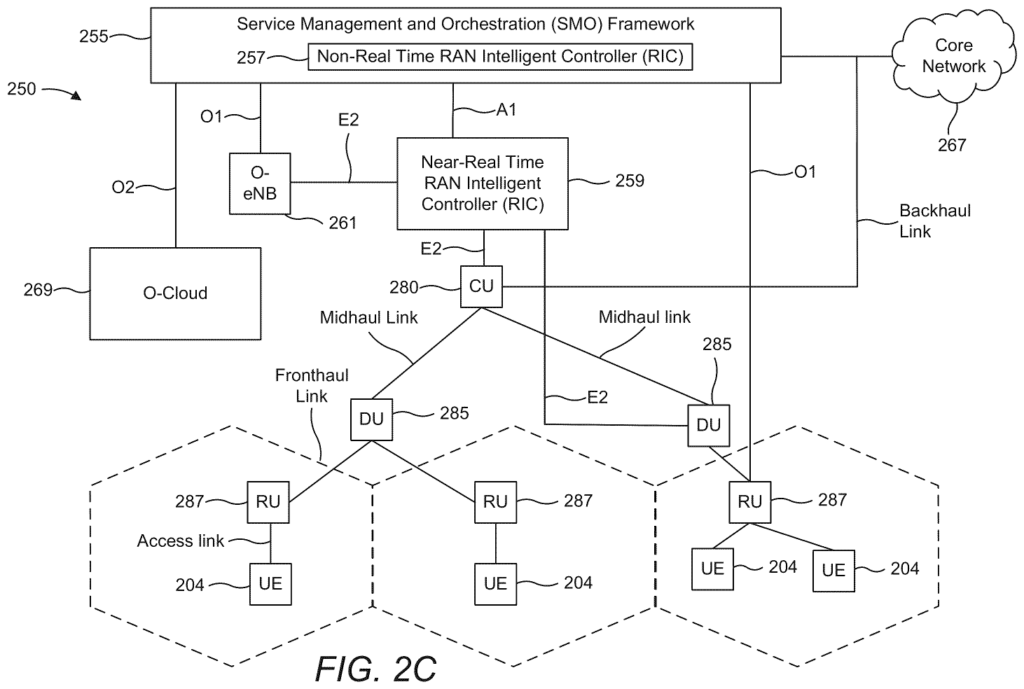

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more RF access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-cNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

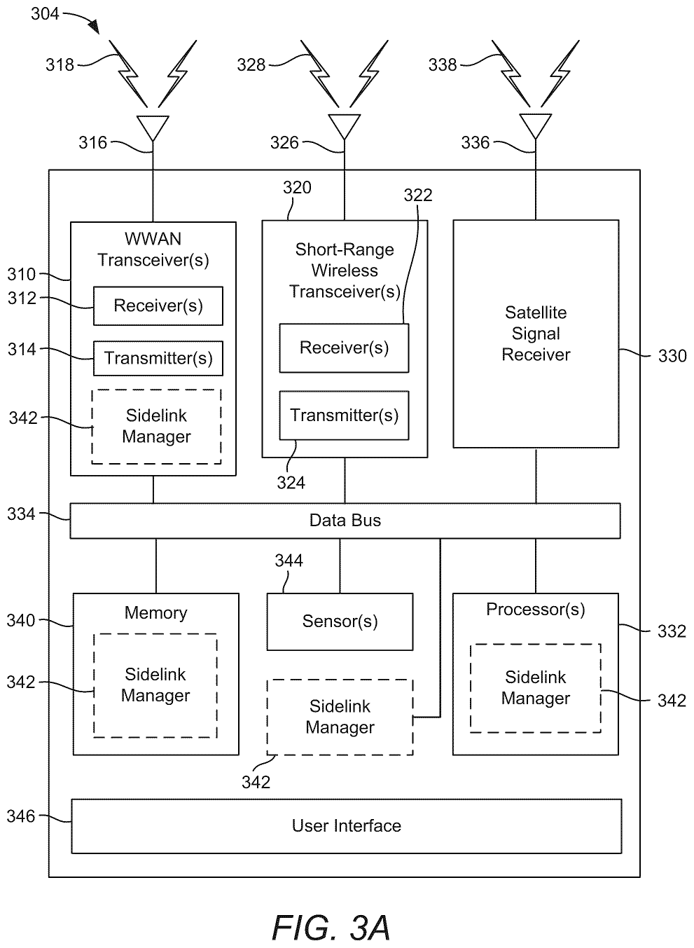

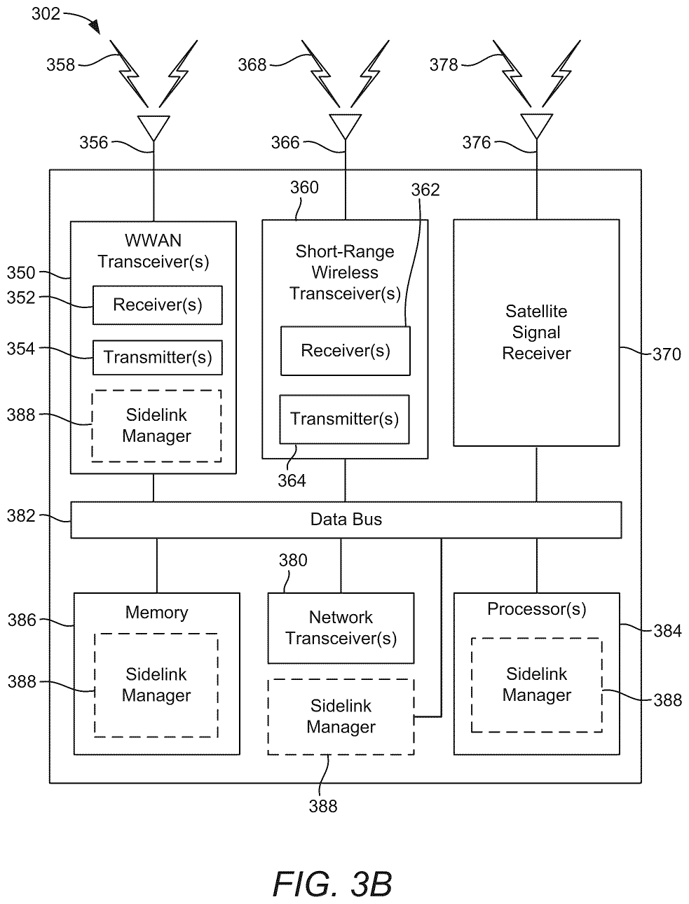

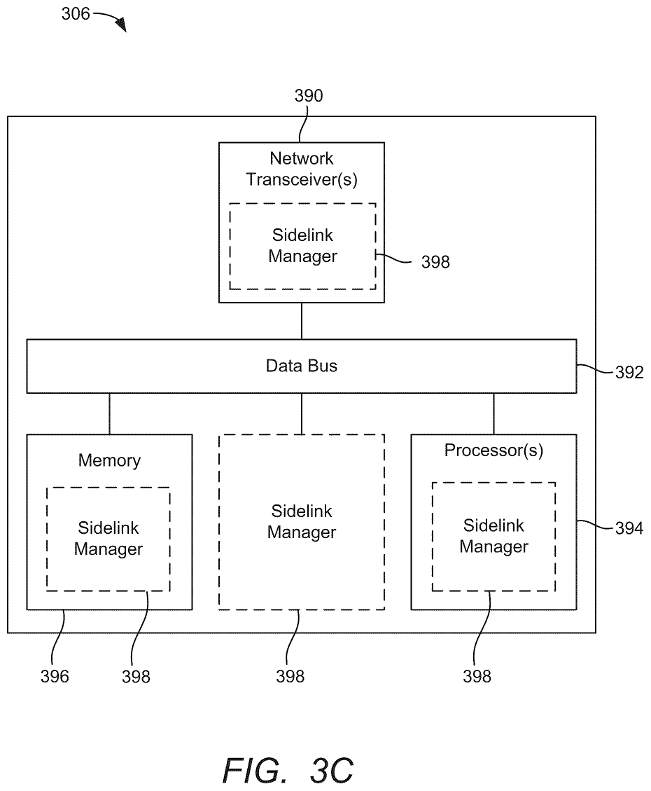

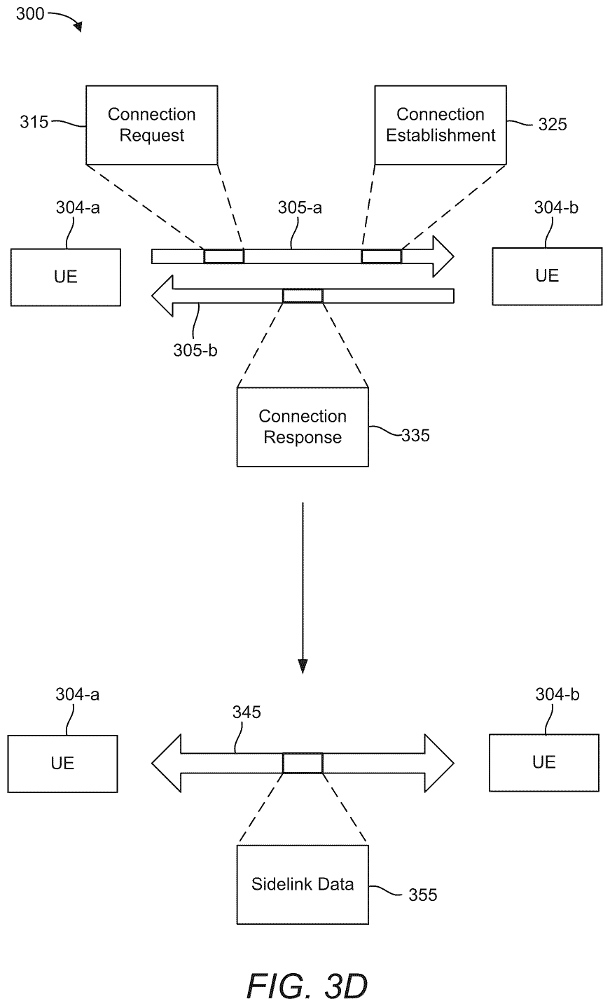

FIGS. 3A, 3B, and 3C illustrate several example components (represented by corresponding blocks) that may be incorporated into a UE 304 (which may correspond to any of the UEs described herein), a base station 302 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatus in different implementations (e.g., in an ASIC, in a system-on-chip (SoC), etc.). The illustrated components may also be incorporated into other apparatus in a communication system. For example, other apparatus in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 304 and the base station 302 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 304 and the base station 302 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 304 and the base station 302 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 304 and the base station 302, respectively, using measurements obtained by any suitable satellite positioning system algorithm.

The base station 302 and the network entity 306 each include one or more network transceivers 380 and 390, respectively, providing means for communicating (e.g., means for transmitting, means for receiving, etc.) with other network entities (e.g., other base stations 302, other network entities 306). For example, the base station 302 may employ the one or more network transceivers 380 to communicate with other base stations 302 or network entities 306 over one or more wired or wireless backhaul links. As another example, the network entity 306 may employ the one or more network transceivers 390 to communicate with one or more base station 302 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 304, base station 302) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 304, base station 302) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 304) and a base station (e.g., base station 302) will generally relate to signaling via a wireless transceiver.

The UE 304, the base station 302, and the network entity 306 also include other components that may be used in conjunction with the operations as disclosed herein. The UE 304, the base station 302, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 304, the base station 302, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 304, the base station 302, and the network entity 306 may include sidelink manager 342, 388, and 398, respectively. The sidelink manager 342, 388, and 398 may be hardware circuits that are part of or coupled to the processors 332, 384, and 394, respectively, that, when executed, cause the UE 304, the base station 302, and the network entity 306 to perform the functionality described herein. In other aspects, the sidelink manager 342, 388, and 398 may be external to the processors 332, 384, and 394 (e.g., part of a modem processing system, integrated with another processing system, etc.). Alternatively, the sidelink manager 342, 388, and 398 may be memory modules stored in the memories 340, 386, and 396, respectively, that, when executed by the processors 332, 384, and 394 (or a modem processing system, another processing system, etc.), cause the UE 304, the base station 302, and the network entity 306 to perform the functionality described herein. FIG. 3A illustrates possible locations of the sidelink manager 342, which may be, for example, part of the one or more WWAN transceivers 310, the memory 340, the one or more processors 332, or any combination thereof, or may be a standalone component. FIG. 3B illustrates possible locations of the sidelink manager 388, which may be, for example, part of the one or more WWAN transceivers 350, the memory 386, the one or more processors 384, or any combination thereof, or may be a standalone component. FIG. 3C illustrates possible locations of the sidelink manager 398, which may be, for example, part of the one or more network transceivers 390, the memory 396, the one or more processors 394, or any combination thereof, or may be a standalone component.

The UE 304 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 304 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 302 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 304. Each spatial stream may then be provided to one or more different antennas 356. The transmitter 354 may modulate an RF carrier with a respective spatial stream for transmission.

At the UE 304, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 304. If multiple spatial streams are destined for the UE 304, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 302. These soft decisions may be based on channel estimates computed by a channel estimator. The soft decisions are then decoded and de-interleaved to recover the data and control signals that were originally transmitted by the base station 302 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 302, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 302 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 302 in a manner similar to that described in connection with the receiver function at the UE 304. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 304. IP packets from the one or more processors 384 may be provided to the core network. The one or more processors 384 are also responsible for error detection.

For convenience, the UE 304, the base station 302, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 304 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 302 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 304, the base station 302, and the network entity 306 may be communicatively coupled to each other over data buses 334, 382, and 392, respectively. In an aspect, the data buses 334, 382, and 392 may form, or be part of, a communication interface of the UE 304, the base station 302, and the network entity 306, respectively. For example, where different logical entities are embodied in the same device (e.g., gNB and location server functionality incorporated into the same base station 302), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 304 (e.g., by execution of appropriate code and/or by appropriate configuration of processor components). Similarly, some or all of the functionality represented by blocks 350 to 388 may be implemented by processor and memory component(s) of the base station 302 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 304, base station 302, network entity 306, etc., such as the processors 332, 384, 394, the transceivers 310, 320, 350, and 360, the memories 340, 386, and 396, the sidelink manager 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 304 via the base station 302 or independently from the base station 302 (e.g., over a non-cellular communication link, such as WiFi).

FIG. 3D illustrates an example of a wireless communications system 300 that supports wireless unicast sidelink establishment, according to aspects of the disclosure. In some examples, wireless communications system 300 may implement aspects of wireless communications systems 100, 200, and 250. Wireless communications system 300 may include a first UE 304-a and a second UE 304-b, which may be examples of any of the UEs described herein. As specific examples, UEs 304-a and 304-b may correspond to V-UEs 160 in FIG. 1.

In the example of FIG. 3D, the UE 304-a may attempt to establish a unicast connection over a sidelink with the UE 304-b, which may be a V2X sidelink between the UE 304-a and UE 304-b. As specific examples, the established sidelink connection may correspond to sidelinks 162 and/or 168 in FIG. 1. The sidelink connection may be established in an omni-directional frequency range (e.g., FR1) and/or a mmW frequency range (e.g., FR2). In some cases, the UE 304-a may be referred to as an initiating UE that initiates the sidelink connection procedure, and the UE 304-b may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 304-a and UE 304-b. For example, a transmission and reception capability matching may be negotiated between the UE 304-a and UE 304-b. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 304-a and UE 304-b. Additionally, a security association may be established between UE 304-a and UE 304-b for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally, IP configurations (e.g., IP versions, addresses, etc.) may be negotiated for the unicast connection between UE 304-a and UE 304-b.

In some cases, UE 304-b may create a service announcement (e.g., a service capability message) to transmit over a cellular network (e.g., cV2X) to assist the sidelink connection establishment. Conventionally, UE 304-a may identify and locate candidates for sidelink communications based on a basic service message (BSM) broadcasted unencrypted by nearby UEs (e.g., UE 304-b). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 304-a is able to detect the BSM(s). Accordingly, the service announcement transmitted by UE 304-b and other nearby UEs (e.g., a discovery signal) may be an upper layer signal and broadcasted (e.g., in an NR sidelink broadcast). In some cases, the UE 304-b may include one or more parameters for itself in the service announcement, including connection parameters and/or capabilities it possesses. The UE 304-a may then monitor for and receive the broadcasted service announcement to identify potential UEs for corresponding sidelink connections. In some cases, the UE 304-a may identify the potential UEs based on the capabilities each UE indicates in their respective service announcements.

The service announcement may include information to assist the UE 304-a (e.g., or any initiating UE) to identify the UE transmitting the service announcement (UE 304-b in the example of FIG. 3D). For example, the service announcement may include channel information where direct communication requests may be sent. In some cases, the channel information may be RAT-specific (e.g., specific to LTE or NR) and may include a resource pool within which UE 304-a transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 304-a to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential sidelink connection target (UE 304-b in the example of FIG. 3D), the initiating UE (UE 304-a in the example of FIG. 3D) may transmit a connection request 315 to the identified target UE 304-b. In some cases, the connection request 315 may be a first RRC message transmitted by the UE 304-a to request a unicast connection with the UE 304-b (e.g., an “RRCSetupRequest” message). For example, the unicast connection may utilize the PC5 interface for the sidelink, and the connection request 315 may be an RRC connection setup request message. Additionally, the UE 304-a may use a sidelink signaling radio bearer 305-a to transport the connection request 315.

After receiving the connection request 315, the UE 304-b may determine whether to accept or reject the connection request 315. The UE 304-b may base this determination on a transmission/reception capability, an ability to accommodate the unicast connection over the sidelink, a particular service indicated for the unicast connection, the contents to be transmitted over the unicast connection, or a combination thereof. For example, if the UE 304-a wants to use a first RAT to transmit or receive data, but the UE 304-b does not support the first RAT, then the UE 304-b may reject the connection request 315. Additionally or alternatively, the UE 304-b may reject the connection request 315 based on being unable to accommodate the unicast connection over the sidelink due to limited radio resources, a scheduling issue, etc. Accordingly, the UE 304-b may transmit an indication of whether the request is accepted or rejected in a connection response 335. Similar to the UE 304-a and the connection request 315, the UE 304-b may use a sidelink signaling radio bearer 305-b to transport the connection response 335. Additionally, the connection response 335 may be a second RRC message transmitted by the UE 304-b in response to the connection request 315 (e.g., an “RRCResponse” message).

In some cases, sidelink signaling radio bearers 305-a and 305-b may be the same sidelink signaling radio bearer or may be separate sidelink signaling radio bearers. Accordingly, a radio link control (RLC) layer acknowledged mode (AM) may be used for sidelink signaling radio bearers 305-a and 305-b. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 335 indicates that the UE 304-b accepted the connection request 315, the UE 304-a may then transmit a connection establishment 325 message on the sidelink signaling radio bearer 305-a to indicate that the unicast connection setup is complete. In some cases, the connection establishment 325 may be a third RRC message (e.g., an “RRCSetupComplete” message). Each of the connection request 315, the connection response 335, and the connection establishment 325 may use a basic capability when being transported from one UE to the other UE to enable each UE to be able to receive and decode the corresponding transmission (e.g., the RRC messages).

Additionally, identifiers may be used for each of the connection request 315, the connection response 335, and the connection establishment 325. For example, the identifiers may indicate which UE 304-a/304-b is transmitting which message and/or for which UE 304-a/304-b the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 315 and/or the connection response 335 for UE 304-a and/or UE 304-b, respectively, to enable negotiation of corresponding AS layer parameters for the unicast connection. For example, the UE 304-a and/or UE 304-b may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 304-a and/or UE 304-b may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 304-a and/or UE 304-b may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 304-a and/or UE 304-b may include PHY layer parameters when establishing the unicast connection to set a PHY layer context for the unicast connection. For example, the PHY layer context may indicate a transmission format (unless transmission profiles are included for each UE 304-a/304-b) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 325 message is transmitted). Before a security association (e.g., security context) is established between the UE 304-a and UE 304-b, the sidelink signaling radio bearers 305-a and 305-b may not be protected. After a security association is established, the sidelink signaling radio bearers 305-a and 305-b may be protected. Accordingly, the security context may enable secure data transmissions over the unicast connection and the sidelink signaling radio bearers 305-a and 305-b. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 304-b may base its decision on whether to accept or reject the connection request 315 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 304-a and UE 304-b may communicate using the unicast connection over a sidelink 345, where sidelink data 355 is transmitted between the two UEs 304-a and 304-b. The sidelink 345 may correspond to sidelinks 162 and/or 168 in FIG. 1. In some cases, the sidelink data 355 may include RRC messages transmitted between the two UEs 304-a and 304-b. To maintain this unicast connection on sidelink 345, UE 304-a and/or UE 304-b may transmit a keep alive message (e.g., “RRCLinkAlive” message, a fourth RRC message, etc.). In some cases, the keep alive message may be triggered periodically or on-demand (e.g., event-triggered). Accordingly, the triggering and transmission of the keep alive message may be invoked by UE 304-a or by both UE 304-a and UE 304-b. Additionally or alternatively, a MAC control element (CE) (e.g., defined over sidelink 345) may be used to monitor the status of the unicast connection on sidelink 345 and maintain the connection. When the unicast connection is no longer needed (e.g., UE 304-a travels far enough away from UE 304-b), either UE 304-a and/or UE 304-b may start a release procedure to drop the unicast connection over sidelink 345. Accordingly, subsequent RRC messages may not be transmitted between UE 304-a and UE 304-b on the unicast connection.

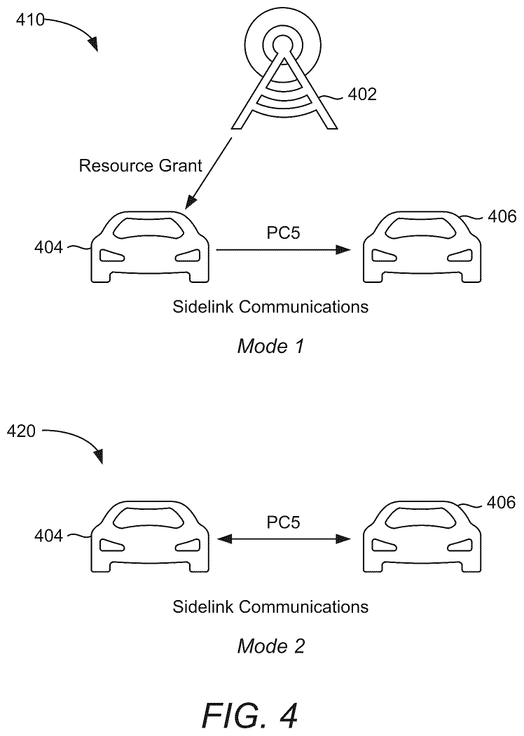

FIG. 4 illustrates the two resource allocation modes for transmissions on NR sidelinks, according to aspects of the disclosure. In the first mode 410 (labeled “Mode 1”), the base station 402 (e.g., any of the base stations described herein) allocates time and/or frequency resources for sidelink communication between the involved V-UEs 404 and 406 (e.g., any of the V-UEs or sidelink-capable UEs described herein) via DCI 3_0. Each V-UE uses the allocated resources to transmit ranging signals (e.g., SL-PRS) to the other V-UE(s).

In the second mode 420 (labeled “Mode 2”), the involved UEs 404 and 406 autonomously select sidelink resources to use for transmission of ranging signals. A V-UE can only use the first mode if it has cellular coverage, and can use the second mode regardless of whether or not it has cellular coverage. Note that although FIG. 4 illustrates two V-UEs, as will be appreciated, they need not be V-UEs, and may instead be any other type of UE capable of sidelink communication. In addition, there may be more than the two V-UEs 404 and 406 illustrated.

Signaling over the sidelink is the same between the two resource allocation modes. From the point of view of the receiver (e.g., V-UE 406), there is no difference between the modes. That is, it does not matter to the receiver whether the resources for the ranging signals were allocated by the base station 402 or the transmitter.

Mode 1 supports dynamic grant (DG), configured grant (CG) Type 1, and CG Type 2. In some cases, CG Type 1 is activated via RRC signaling from the base station 402. In some cases, the modulation and coding scheme (MCS) for sidelink transmissions is determined by the involved V-UEs 404 and 406 within limits set by the base station 402. In Mode 2, the transmitting V-UE (e.g., V-UE 404) performs channel sensing by blindly decodes all physical sidelink control channels (PSCCHs) to determine the resources reserved for other sidelink transmissions. The transmitting V-UE 404 reports available resources to its upper layer and the upper layer determines resource usage.

In addition, NR sidelinks support hybrid automatic repeat request (HARQ) retransmission. In Mode 1, the base station 402 provides a dynamic grant for HARQ feedback or activates a configured sidelink grant. The sidelink feedback can be reported back to the base station by the transmitting UE (e.g., V-UE 404).

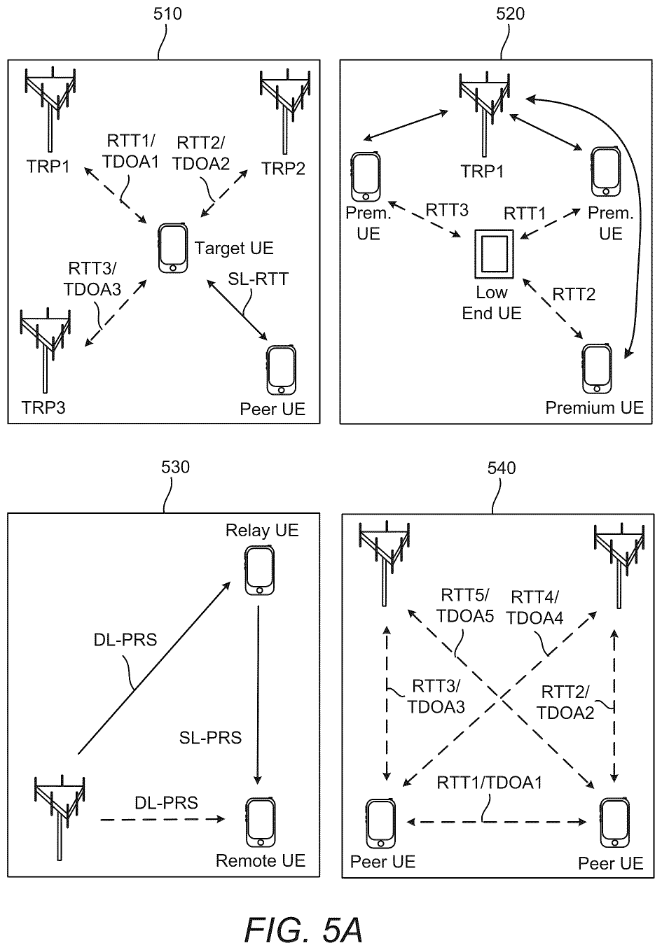

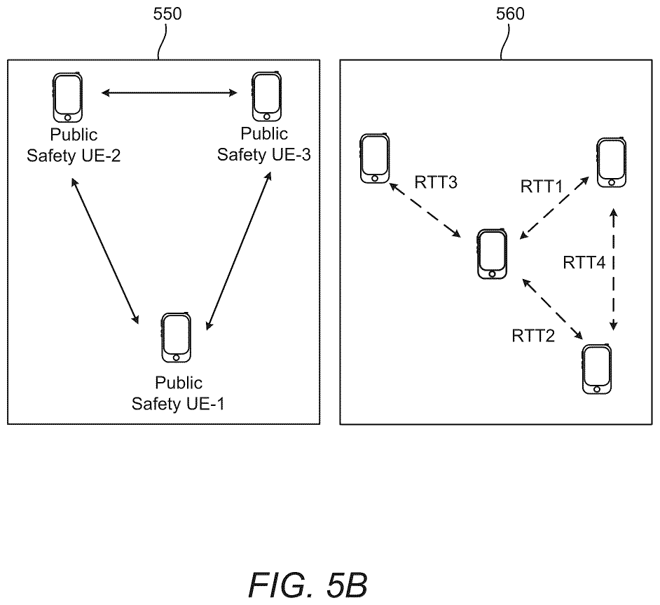

NR supports, or enables, various sidelink positioning techniques. FIG. 5A illustrates various scenarios of interest for sidelink-only or joint Uu and sidelink positioning, according to aspects of the disclosure. In scenario 510, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 520, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 530, a relay UE (e.g., with a known location) participates in the positioning estimation of a remote UE without performing uplink positioning reference signal (PRS) transmission over the Uu interface. Scenario 540 illustrates the joint positioning of multiple UEs. Specifically, in scenario 540, two UEs with unknown positions can be jointly located in non-line-of-sight (NLOS) conditions by utilizing constraints from nearby UEs.

FIG. 5B illustrates additional scenarios of interest for sidelink-only or joint Uu and sidelink positioning, according to aspects of the disclosure. In scenario 550, UEs used for public safety (e.g., by police, firefighters, and/or the like) may perform peer-to-peer (P2P) positioning and ranging for public safety and other uses. For example, in scenario 550, the public safety UEs may be out of coverage of a network and determine a location or a relative distance and a relative position among the public safety UEs using sidelink positioning techniques. Similarly, scenario 560 shows multiple UEs that are out of coverage and determine a location or a relative distance and a relative position using sidelink positioning techniques, such as SL-RTT.

Sidelink communication takes place in transmission or reception resource pools. In the frequency domain, the minimum resource allocation unit is a sub-channel (e.g., a collection of consecutive PRBs in the frequency domain). In the time domain, resource allocation is in one slot intervals. However, some slots are not available for sidelink, and some slots contain feedback resources. In addition, sidelink resources can be (pre) configured to occupy fewer than the 14 symbols of a slot.

Sidelink resources are configured at the radio resource control (RRC) layer. The RRC configuration can be by pre-configuration (e.g., preloaded on the UE) or configuration (e.g., from a serving base station).

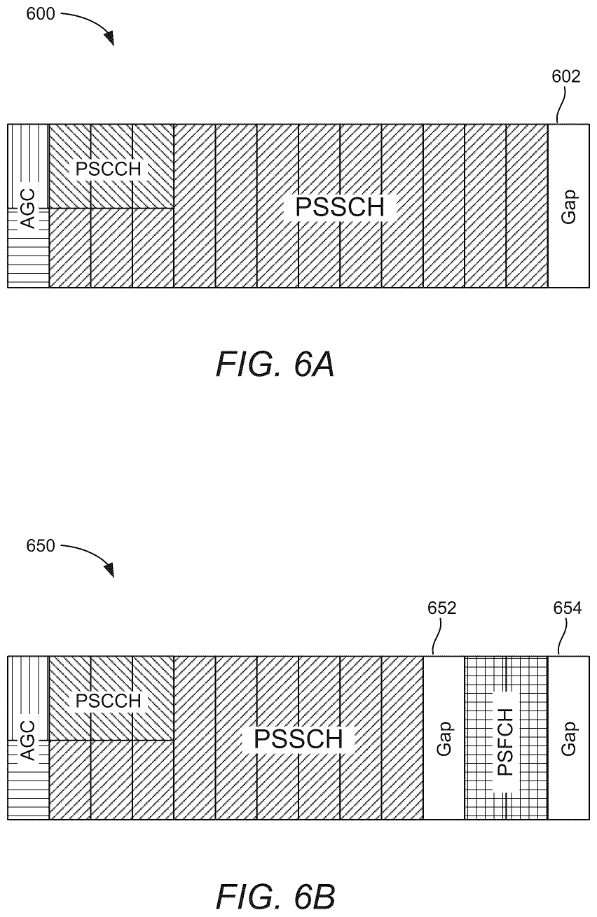

NR sidelinks support hybrid automatic repeat request (HARQ) retransmission. FIG. 6A is a diagram 600 of an example slot structure without feedback resources, according to aspects of the disclosure. In the example of FIG. 6A, time is represented horizontally and frequency is represented vertically. In the time domain, the length of each block is one orthogonal frequency division multiplexing (OFDM) symbol, and the 14 symbols make up a slot. In the frequency domain, the height of each block is one sub-channel. Currently, the (pre) configured sub-channel size can be selected from the set of {10, 15, 20, 25, 50, 75, 100} physical resource blocks (PRBs).

For a sidelink slot, the first symbol is a repetition of the preceding symbol and is used for automatic gain control (AGC) setting. This is illustrated in FIG. 6A by the vertical and horizontal hashing. As shown in FIG. 6A, for sidelink, the PSCCH and the physical sidelink shared channel (PSSCH) are transmitted in the same slot. Similar to the physical downlink control channel (PDCCH), the PSCCH carries control information about sidelink resource allocation and descriptions about sidelink data transmitted to the UE. Likewise, similar to the physical downlink shared channel (PDSCH), the PSSCH carries user data for the UE. In the example of FIG. 6A, the PSCCH occupies half the bandwidth of the sub-channel and only three symbols. Finally, a gap period or symbol 602 is present after the PSSCH.

FIG. 6B is a diagram 650 of an example slot structure with feedback resources, according to aspects of the disclosure. In the example of FIG. 6B, time is represented horizontally and frequency is represented vertically. In the time domain, the length of each block is one OFDM symbol, and the 14 symbols make up a slot. In the frequency domain, the height of each block is one sub-channel.

The slot structure illustrated in FIG. 6B is similar to the slot structure illustrated in FIG. 6A, except that the slot structure illustrated in FIG. 6B includes feedback resources. Specifically, two symbols at the end of the slot have been dedicated to the physical sidelink feedback channel (PSFCH). The first PSFCH symbol is a repetition of the second PSFCH symbol for AGC setting. In addition to the gap symbol 652 after the PSSCH, there is a gap symbol 654 after the two PSFCH symbols. Additional gap symbols, sometimes referred to as guard periods or guard symbols, may be located in various symbol positions in various slot structures. Currently, resources for the PSFCH can be configured with a periodicity selected from the set of {0, 1, 2, 4} slots.

The PSCCH carries SCI. First stage SCI (referred to as “SCI-1”) is transmitted on the PSCCH and contains information for resource allocation and decoding second stage SCI (referred to as “SCI-2”). SCI-2 is transmitted on the PSSCH and contains information for decoding the data that will be transmitted on the shared channel (SCH) of the sidelink. SCI-1 information is decodable by all UEs, whereas SCI-2 information may include formats that are only decodable by certain UEs. This ensures that new features can be introduced in SCI-2 while maintaining resource reservation backward compatibility in SCI-1.

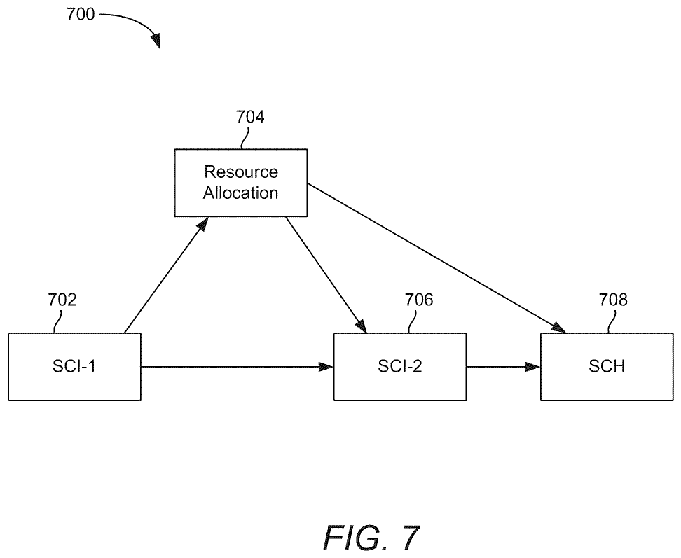

Both SCI-1 and SCI-2 use the physical downlink control channel (PDCCH) polar coding chain, illustrated in FIG. 7. FIG. 7 is a diagram 700 showing how the shared channel (SCH) is established on a sidelink between two or more UEs, according to aspects of the disclosure. Specifically, information in the SCI-1 702 is used for resource allocation 704 (by the network or the involved UEs) for the SCI-2 706 and SCH 708. In addition, information in the 7CI-1 702 is used to determine/decode the contents of the SCI-2 706 transmitted on the allocated resources. Thus, a receiver UE needs both the resource allocation 704 and the SCI-1 702 to decode the SCI-2 706. Information in the SCI-2 706 is then used to determine/decode the SCH 708.

The first 13 symbols of a slot in the time domain and the allocated subchannel(s) in the frequency domain form a sidelink resource pool. A sidelink resource pool may include resources for sidelink communication (transmission and/or reception), sidelink positioning (referred to as a resource pool for positioning (RP-P)), or both communication and positioning. A resource pool configured for both communication and positioning is referred to as a “shared” resource pool. In a shared resource pool, the RP-P is indicated by an offset, periodicity, number of consecutive symbols within a slot (e.g., as few as one symbol), and/or the bandwidth within a component carrier (or the bandwidth across multiple component carriers). In addition, the RP-P can be associated with a zone or a distance from a reference location.

A base station (or a UE, depending on the resource allocation mode) can assign, to another UE, one or more resource configurations from the RP-Ps. Additionally or alternatively, a UE (e.g., a relay or a remote UE) can request one or more RP-P configurations, and it can include in the request one or more of the following: (1) its location information (or zone identifier), (2) periodicity, (3) bandwidth. (4) offset, (5) number of symbols, and (6) whether a configuration with “low interference” is needed (which can be determined through an assigned quality of service (QOS) or priority).

A base station or a UE can configure/assign rate matching resources or RP-P for rate matching and/or muting to a sidelink UE such that when a collision exists between the assigned resources and another resource pool that contains data (e.g., PSSCH) and/or control (e.g., PSCCH), the sidelink UE is expected to rate match, mute, and/or puncture the data, DMRS, and/or CSI-RS within the colliding resources. This would enable orthogonalization between positioning and data transmissions for increased coverage of PRS signals.

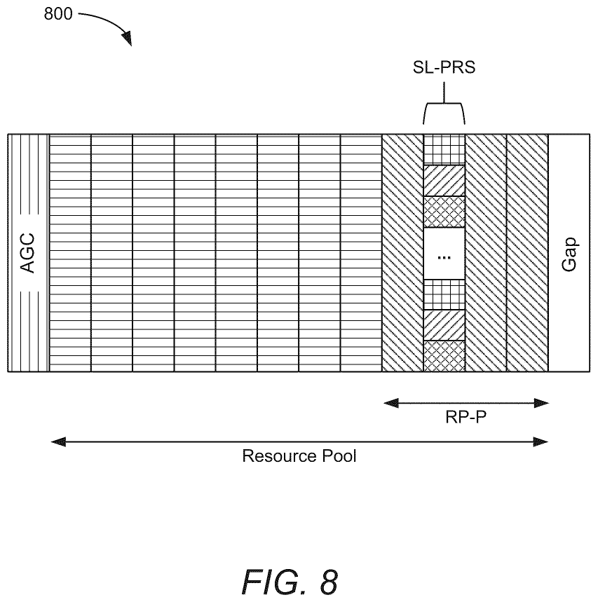

FIG. 8 is a diagram 800 illustrating an example of a resource pool for positioning configured within a sidelink resource pool for communication (i.e., a shared resource pool), according to aspects of the disclosure. In the example of FIG. 8, time is represented horizontally and frequency is represented vertically. In the time domain, the length of each block is an orthogonal frequency division multiplexing (OFDM) symbol, and the 14 symbols make up a slot. In the frequency domain, the height of each block is a sub-channel.

In the example of FIG. 8, the entire slot (except for the first and last symbols) can be a resource pool for sidelink communication. That is, any of the symbols other than the first and last can be allocated for sidelink communication. However, an RP-P is allocated in the last four pre-gap symbols of the slot. As such, non-sidelink positioning data, such as user data (e.g., PSSCH), CSI-RS, and control information, can only be transmitted in the first eight post-AGC symbols and not in the last four pre-gap symbols to prevent a collision with the configured RP-P. The non-sidelink positioning data that would otherwise be transmitted in the last four pre-gap symbols can be punctured or muted, or the non-sidelink data that would normally span more than the eight post-AGC symbols can be rate matched to fit into the eight post-AGC symbols.

Sidelink positioning reference signals (SL-PRS) have been defined to enable sidelink positioning procedures among UEs. Like a downlink PRS (DL-PRS), an SL-PRS resource is composed of one or more resource elements (i.e., one OFDM symbol in the time domain and one subcarrier in the frequency domain). SL-PRS resources have been designed with a comb-based pattern to enable fast Fourier transform (FFT)-based processing at the receiver. SL-PRS resources are composed of unstaggered, or only partially staggered, resource elements in the frequency domain to provide small time of arrival (TOA) uncertainty and reduced overhead of each SL-PRS resource. SL-PRS may also be associated with specific RP-Ps (e.g., certain SL-PRS may be allocated in certain RP-Ps). SL-PRS have also been defined with intra-slot repetition (not shown in FIG. 8) to allow for combining gains (if needed). There may also be inter-UE coordination of RP-Ps to provide for dynamic SL-PRS and data multiplexing while minimizing SL-PRS collisions.

Wireless communication signals (e.g., RF signals configured to carry orthogonal frequency division multiplexing (OFDM) symbols in accordance with a wireless communications standard, such as LTE, NR, etc.) transmitted between a UE and a base station can be used for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, such as Wi-Fi signals, etc. As a particular example, the wireless communication signals may be an OFDM waveform as utilized in LTE and NR. High-frequency communication signals, such as millimeter wave (mmW) RF signals, are especially beneficial to use as radar signals because the higher frequency provides, at least, more accurate range (distance) detection.

Possible use cases of RF sensing include health monitoring use cases, such as heartbeat detection, respiration rate monitoring, and the like, gesture recognition use cases, such as human activity recognition, keystroke detection, sign language recognition, and the like, contextual information acquisition use cases, such as location detection/tracking, direction finding, range estimation, and the like, and automotive radar use cases, such as smart cruise control, collision avoidance, and the like.

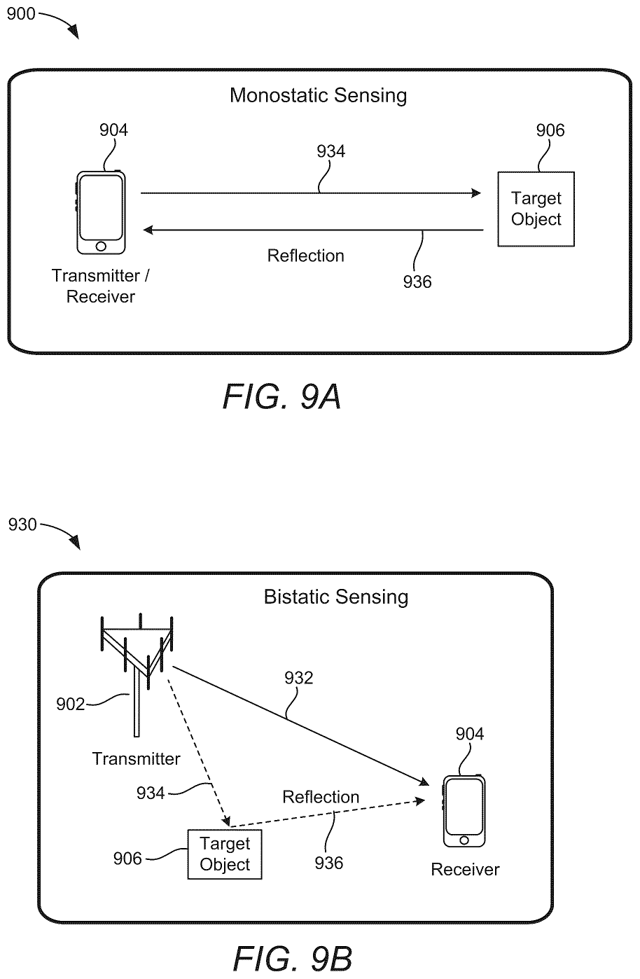

There are different types of sensing, including monostatic sensing (also referred to as “active sensing”) and bistatic sensing (also referred to as “passive sensing”). FIGS. 9A and 9B illustrate these different types of sensing. Specifically, FIG. 9A is a diagram 900 illustrating a monostatic sensing scenario and FIG. 9B is a diagram 930 illustrating a bistatic sensing scenario. In FIG. 9A, the transmitter (Tx) and receiver (Rx) are co-located in the same sensing device 904 (e.g., a UE). The sensing device 904 transmits one or more RF sensing signals 934 (e.g., uplink or sidelink positioning reference signals (PRS) where the sensing device 904 is a UE), and some of the RF sensing signals 934 reflect off a target object 906. The sensing device 904 can measure various properties (e.g., times of arrival (ToAs), angles of arrival (AoAs), phase shift, etc.) of the reflections 936 of the RF sensing signals 934 to determine characteristics of the target object 906 (e.g., size, shape, speed, motion state, etc.).

In FIG. 9B, the transmitter (Tx) and receiver (Rx) are not co-located, that is, they are separate devices (e.g., a UE and a base station). Note that while FIG. 9B illustrates using a downlink RF signal as the RF sensing signal 932, uplink RF signals or sidelink RF signals can also be used as RF sensing signals 932. In a downlink scenario, as shown, the transmitter is a base station and the receiver is a UE, whereas in an uplink scenario, the transmitter is a UE and the receiver is a base station.

Referring to FIG. 9B in greater detail, the transmitter device 902 transmits RF sensing signals 932 and 934 (e.g., positioning reference signals (PRS)) to the sensing device 904, but some of the RF sensing signals 934 reflect off a target object 906. The sensing device 904 (also referred to as the “sensing device”) can measure the times of arrival (ToAs) of the RF sensing signals 932 received directly from the transmitter device and the ToAs of the reflections 936 of the RF sensing signals 934 reflected from the target object 906.

More specifically, as described above, a transmitter device (e.g., a base station) may transmit a single RF signal or multiple RF signals to a sensing device (e.g., a UE). However, the receiver may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 9B, the RF sensing signals 932 followed the LOS path between the transmitter device 902 and the sensing device 904, and the RF sensing signals 934 followed an NLOS path between the transmitter device 902 and the sensing device 904 due to reflecting off the target object 906. The transmitter device 902 may have transmitted multiple RF sensing signals 932, 934, some of which followed the LOS path and others of which followed the NLOS path. Alternatively, the transmitter device 902 may have transmitted a single RF sensing signal in a broad enough beam that a portion of the RF sensing signal followed the LOS path (RF sensing signal 932) and a portion of the RF sensing signal followed the NLOS path (RF sensing signal 934).

Based on the ToA of the LOS path, the ToA of the NLOS path, and the speed of light, the sensing device 904 can determine the distance to the target object(s). For example, the sensing device 904 can calculate the distance to the target object as the difference between the ToA of the LOS path and the ToA of the NLOS path multiplied by the speed of light. In addition, if the sensing device 904 is capable of receive beamforming, the sensing device 904 may be able to determine the general direction to a target object as the direction (angle) of the receive beam on which the RF sensing signal following the NLOS path was received. That is, the sensing device 904 may determine the direction to the target object as the angle of arrival (AoA) of the RF sensing signal, which is the angle of the receive beam used to receive the RF sensing signal. The sensing device 904 may then optionally report this information to the transmitter device 902, its serving base station, an application server associated with the core network, an external client, a third-party application, or some other sensing entity. Alternatively, the sensing device 904 may report the ToA measurements to the transmitter device 902, or other sensing entity (e.g., if the sensing device 904 does not have the processing capability to perform the calculations itself), and the transmitter device 902 may determine the distance and, optionally, the direction to the target object 906.

Note that if the RF sensing signals are uplink RF signals transmitted by a UE to a base station, the base station would perform object detection based on the uplink RF signals just like the UE does based on the downlink RF signals.

Like conventional radar, wireless communication-based radar signal can be used to estimate the range (distance), velocity (Doppler), and angle (AoA) of a target object. However, the performance (e.g., resolution and maximum values of range, velocity, and angle) may depend on the design of the reference signal.

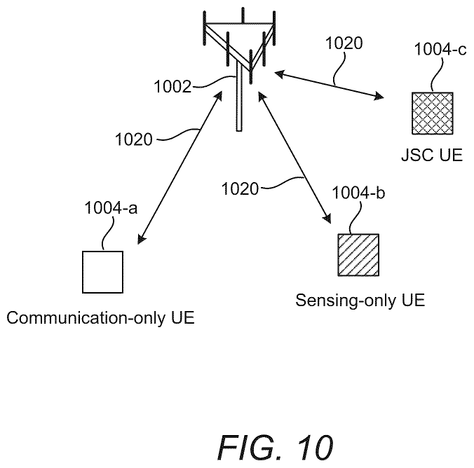

FIG. 10 illustrates a first example of a joint communication and sensing (JCS) system 1000. For example, the JCS system 1000 can be viewed functionally as an integrated system that is configured to simultaneously perform both wireless communication and remote radar sensing. That is, for example, time, frequency, and/or spatial radio resources may be allocated to support multiple purposes (e.g., communication and sensing) in the integrated system. The JCS system 1000 may be included, wholly or partially, in the wireless communication system 100 as described herein. The JCS system 1000 may include a base station 1002 and multiple UEs 1004. For example, UE 1004-a may be a communication-only UE, UE 1004-b may be a sensing-only UE, and UE 1004-c may be a JCS UE. These UEs 1004 may also be referred to as sidelink devices. Base station 1002 may communicate with UEs 1004 via communication links 1020 (e.g., via UL and DL channels).

A communication-only UE or sidelink device such as UE 1004-a may include a set of RF components (e.g., one or more transmitter/receiver pairs and/or transceivers) that is configured to be used for communication with active or cooperative devices that also have one or more transmitter/receiver pairs and/or transceivers. In some examples, the communication-only UE may be temporally configured to be used primarily for communication (e.g., for a particular time period or session) and may be configured for communication and other RF operations during different time periods. A sensing-only UE or sidelink device such as UE 1004-b may include a set of RF components (e.g., one or more transmitter/receiver pairs and/or transceivers) that is configured to be used for sensing purposes. In some examples, the sensing-only UE may also include a way to wirelessly receive and/or transmit signals for communicating with other devices. That is, for example, the sensing-only UE may wirelessly receive instructional information related to sensing operations and/or wirelessly transmit the results of the sensing operations. In some examples, the sensing-only UE may operate in a sensing-only operation mode for a particular time period or session after which the UE may switch to operate in a communication-only operation mode and/or perform some communication with other devices related to the sensing results. A JCS UE or sidelink device such as UE 1004-c may include a set of RF components (e.g., one or more transmitter/receiver pairs and/or transceivers) that is configured to be used for communication and may include a set of RF components (e.g., one or more transmitter/receiver pairs and/or transceivers) that is configured to be used for sensing purposes.

In some examples, a sensing-only UE, such as UE 1004-b and a JCS UE, such as UE 1004-c may perform sensing operations, such as but not limited to an NR-based sensing procedure in which the network (e.g., base station 1002) configures the sensing parameters. In some examples, a network-coordinated sensing procedure may be performed by one or both of UE 1004-b and UE 1004-c. In some examples, the sensing procedure may be coordinated over sidelink channels. A sensing server (e.g., inside or outside the core network) may sends a request for network information to base station 1002 (e.g., the serving base station of one or more UEs 1004). The request may include a list of the serving cell and any neighboring cells. Base station 1002 may send the requested information to the sensing server. The sensing server via base station 1002 may send a request for sensing capabilities to UE 1004, and UE 1004 may provide its sensing capabilities to base station 1002, which may forward the sensing capabilities to the sensing server. The sensing server via base station 1002 may send a configuration to UE 1004 indicating the reference signals (RS) that will be transmitted for sensing. In some examples, the reference signals for sensing may be transmitted by the serving and/or neighboring cells. The sensing server may also send a request for sensing information to UE 1004 via base station 1002. UE 1004 then may measure the transmitted reference signals and may send the measurements, or any sensing results determined from the measurements, to base station 1002, which may forward such measurement and/or sensing results to the sensing server.

In some examples, UEs 1004 may be operating in a sidelink resource allocation mode, such as but not limited to the first mode 410 or Mode 1 as described herein. UEs 1004 may be configured by higher layers (e.g., the RRC layer) with sidelink resource pool(s). The sidelink resource pool(s) may be used by UEs 1004 for transmission of PSSCH. Base station 1002 may transmit a request to report an RF capability of UEs 1004. This request enables base station 1002 to learn the particular type of UE that is in the JCS system 1000.

That is, for example, UE 1004-a may receive the request from base station 1002 to report the RF capability of the UE. Responsive to this request, UE 1004-a may transmit an RF capability type that indicates UE 1004-a is a communication-only UE. Additionally, UE 1004-b may receive the request from base station 1002 to report the RF capability of the UE. Responsive to this request, UE 1004-b may transmit an RF capability type that indicates UE 1004-b is a sensing-only UE. Additionally, UE 1004-c may receive the request from base station 1002 to report the RF capability of the UE. Responsive to this request, UE 1004-c may transmit an RF capability type that indicates UE 1004-c is a JCS UE. Based on the RF capability type of a particular UE 1004, base station 1002 may provide a sidelink allocation to that UE 1004 in consideration of the UE's RF capabilities in the JCS system 1000. In some examples, the request to report the RF capability may originate from or be transmitted by a device other than base station 1002, for example, another UE 1004 or a server in communication with the core network (e.g., 5GC).

UE 1004 may receive a sidelink allocation from base station 1002. That is, for example, UE 1004 may receive a DCI (e.g., DCI format 3_0, etc.) from base station 1002 that includes the sidelink allocation. The sidelink allocation may indicate a set of sidelink resources that UE 1004 can utilize. The set of sidelink resources may include all or a subset of the sidelink resources in the sidelink resource pool(s) configured by higher layers. The sidelink allocation may also indicate sidelink communication resource(s) and/or sidelink sensing resource(s) that are scheduled from the set of sidelink resources. In some examples, the sidelink allocation may originate from or be transmitted by a device other than base station 1002, for example, another UE 1004 in the JCS system 1000.

In some examples, UE 1004-a, after reporting that UE 1004-a is a communication-only UE, may receive a sidelink allocation that includes an indication of sidelink communication resource(s) absent any indication of sidelink sensing resource(s). In some examples, UE 1004-b, after reporting that UE 1004-b is a sensing-only UE, may receive a sidelink allocation that includes an indication of sidelink sensing resource(s) absent any indication of sidelink communication resource(s). In some cases, the sidelink sensing resource(s) allocated to UE 1004-b may be the last symbol of a sidelink slot. That is, for example, a sidelink slot may include some symbols that may be allocated and used for communication, but the last symbol of a sidelink slot is typically a guard period or guard symbol. Base station 1002 may therefore allocate the last period or symbol of the sidelink slot to be used as a sensing resource in accordance with some aspects.

In some examples, UE 1004-c, after reporting that UE 1004-c is a JCS UE, may receive a sidelink allocation that includes an indication of both sidelink communication resource(s) and sidelink sensing resource(s). UE 1004-c may transmit scheduling request(s) to base station 1002 to request a sidelink allocation and base station 1002 may respond by transmitting the sidelink allocation via DCI(s). For example, UE 1004-c may encode a communication scheduling request and a sensing scheduling request in an uplink control information (UCI) and transmit the UCI via a physical uplink control channel (PUCCH). In some examples, the sidelink allocation from base station 1002 may be received by UE 1004-c as a DCI via a physical downlink control channel (PDCCH).

In some examples, UE 1004-c may encode the communication scheduling request in a first UCI and may encode the sensing scheduling request in a second UCI that is different from the first UCI. UE 1004-c may transmit the communication scheduling request in the first UCI via a first PUCCH and may transmit the sensing scheduling request in the second UCI via a second PUCCH different from the first PUCCH. In some cases, the sidelink allocation from base station 1002 may be received by UE 1004-c as a single DCI via a PDCCH. In some cases, the sidelink allocation from base station 1002 may be received by UE 1004-c as a first DCI (e.g., scheduling the sidelink communication resource(s)) via a first PDCCH and a second DCI (e.g., scheduling the sidelink sensing resource(s)) via a second PDCCH different from the first PDCCH. In some examples, the sidelink sensing resource(s) may include resources different from the last symbol of a sidelink slot. That is, for example, the sidelink sensing resource(s) scheduled by base station 1002 may include a symbol within the sidelink slot (e.g., symbol l=4, etc.). In some cases, the symbols scheduled as sidelink sensing resource(s) may be a guard period or guard symbol within the sidelink slot. In some cases, the symbols scheduled as sidelink sensing resource(s) may be a resource within the sidelink slot that could otherwise be scheduled as sidelink communication resource(s).

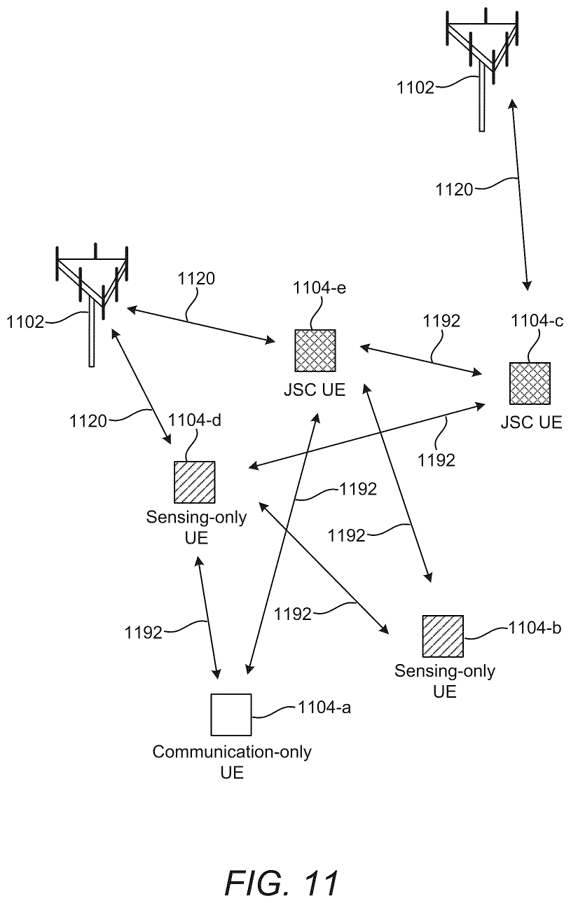

FIG. 11 illustrates a second example of a JCS system 1100. The JCS system 1100 may be included, wholly or partially, in the wireless communication system 100 as described herein. Additionally, the JCS system 1100 may include aspects as described with respect to the JCS system 1000. The JCS system 1100 may include base stations 1002 and multiple UEs 1104. For example, UE 1104-a may be a communication-only UE, UE 1104-b may be a sensing-only UE, UE 1104-c may be a JCS UE, UE 1104-d may also be a sensing-only UE, and UE 1104-e may also be a JCS UE. These UEs 1104 may also be referred to as sidelink devices. In some cases, base stations 1102 may be in the coverage area of all or some UEs 1104. For example, base stations 1102 may communicate with some or all UEs 1104 via communication links 1020 (e.g., via UL and DL channels). In some cases, all of UEs 1104 may be out of coverage from base stations 1102.

In some examples, UEs 1104 may be operating in a sidelink resource allocation mode, such as but not limited to the second mode 420 or Mode 2 as described herein. UEs 1104 may be configured by higher layers (e.g., the RRC layer) with sidelink resource pool(s), for example, when in the coverage area of base station 1102. The sidelink resource pool(s) may be used by UEs 1104 for transmission of PSSCH. In some examples, the sidelink resource pool(s) may include a sidelink sensing resource pool. In some cases, the sidelink sensing resource pool is a pool of resources different from a resource pool for communications. In some examples, the sidelink resource pool(s) may include a joint sidelink communication and sensing resource pool. In some cases, the joint sidelink communication and sensing resource pool is a pool of resources different from a resource pool for communications. That is, for example, the network may preconfigure a joint sidelink communication and sensing resource pool that includes resources different from a pool of resources that are used for sidelink communications-only purposes. UEs 1104 may establish a link 192 (e.g., a D2D P2P link) with one of the other UEs 1104. In some examples, UEs 1104 may transmit SCI (e.g., SCI format 1-A, etc.) via a PSCCH of the link 1192 with one of the other UEs 1104. A UE 1104 may transmit an SCI that includes a sidelink allocation for sidelink operations with other UEs 1104. The sidelink allocation may indicate a set of sidelink resources that UEs 1004 can utilize. The set of sidelink resources may include all or a subset of the sidelink resources in the sidelink resource pool(s) configured by higher layers for the transmitting UE 1104. The sidelink allocation from the transmitting UE 1104 may also indicate sidelink communication resource(s) and/or sidelink sensing resource(s) that are scheduled from the set of sidelink resources.

For example, while in Mode 2, UE 1104-d or UE 1104-e may transmit an SCI that includes sidelink sensing resource(s) for reservation. That is, for example, reservation of sidelink sensing resource(s) may be performed by a UE with an RF capability type configured for sensing operations (e.g., a sensing-only UE or a JCS UE) in accordance with some aspects. In some cases, base station 1102 may configure or indicate to a UE 1104 (e.g., UE 1104-d) that UE 1104 may only reserve sidelink sensing resource(s) in the last symbol of a sidelink slot. That is, for example, the last symbol of a sidelink slot may be a guard period or guard symbol when the sidelink slot is used for sidelink communication. In some cases, base station 1102 may configure or indicate to a UE 1104 (e.g., UE 1104-c) that that UE 1104 may reserve sidelink sensing resource(s) in symbol positions other than the last symbol of a sidelink slot.

In some examples, UE 1104-d or UE 1104-e may determine that the sidelink sensing resource(s) are to be used for bistatic sensing. That is, for example, UE 1104-e may be instructed by base station 1102 or make a determination based on operational instructions or guidelines (e.g., logistics operations) that a bistatic sensing procedure is to be performed with one or more other UEs 1104. In some cases, UE 1104-e may be attempting to identify an existence, locate a position, and/or track an uncooperative target using the bistatic sensing procedure in the JCS system 1100. That is, for example, an uncooperative target can be an object or device absent any wireless transmissions. Additionally, or alternatively, an uncooperative target can be a device incapable of or unwilling to establish communication with the devices in the JCS system 1100. Identifying, locating, and/or tracking an uncooperative target means that UE 1104-e and the other UEs 1104 can only use their own measurements without any communication or negotiation procedures with the uncooperative target. In some cases, UE 1104-e may transmit an SCI that includes control information of a sensing waveform associated with the one or more sidelink sensing resources. In some examples, the SCI may be formatted to indicate that the sensing waveform corresponds to a phase-coded frequency-modulated frequency wave (PC-FMCW). It is to be understood that other waveforms, such as but not limited to various chirp signal waveforms may be indicated in the SCI.

In some examples, while in Mode 2, UE 1104-e may transmit SCI that reserves both sidelink communication resource(s) and sidelink sensing resource(s). That is, for example, reservation of both sidelink communication resource(s) and sidelink sensing resource(s) may be performed by a UE with an RF capability type configured for JCS operations (e.g., a JCS UE) in accordance with some aspects. UE 1104-e may format the SCI to indicate various ways in which the sidelink communication resource(s) and sidelink sensing resource(s) may be reserved for JCS operations. For example, the SCI may include a semi-persistent scheduling of the sidelink communication resource(s) and a semi-persistent scheduling of the sidelink sensing resource(s).

With reference to the slot structure of FIG. 6A, UE 1104-e may format an SCI to indicate that the 9 symbols of PSSCH for each sidelink slot are semi-persistently scheduled as sidelink communication resources and the gap period or symbol 602 after the PSSCH for each sidelink slot is also semi-persistently scheduled as sidelink sensing resources. In some cases, one or more guard periods or symbols in a sidelink communication slot may be used for sensing purposes. That is, for example, UE 1104-e knows the positions of the guard periods or symbols in the sidelink communication slot to be semi-persistently reserved for sidelink communication resources and may indicate that some or all of the guard periods or guard symbols are to be used as sidelink sensing resources.

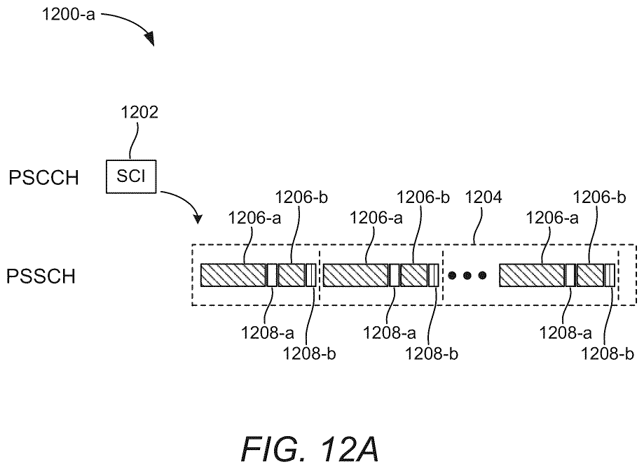

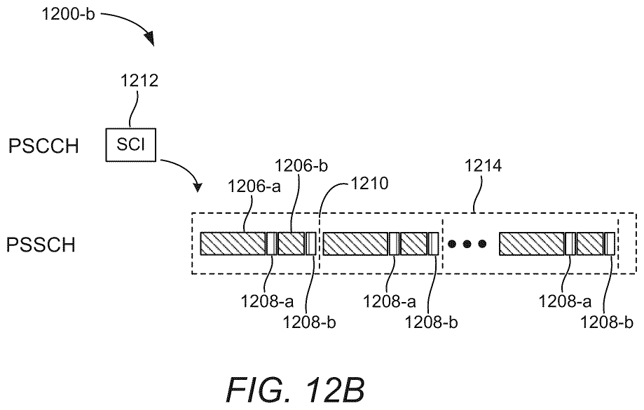

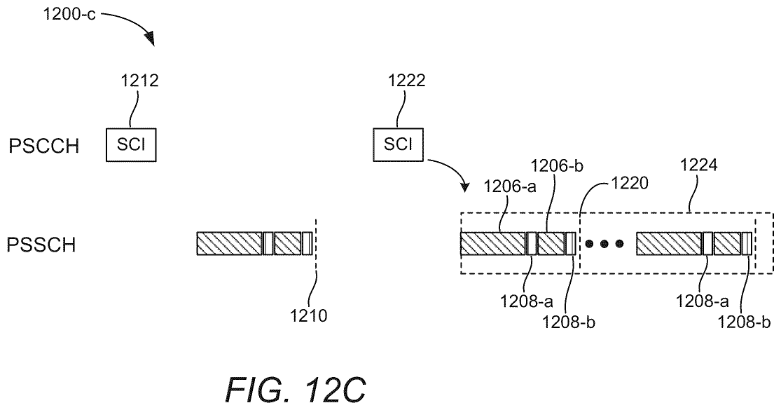

As an additional example and as illustrated in example SCI scenario 1200-a of FIG. 12A, UE 1104-c may format SCI 1202 and transmit SCI 1202 on PSCCH. SCI 1202 may indicate a reservation 1204 that includes a semi-persistent scheduling of both sidelink communication resources and sidelink sensing resources. That is, for example, SCI 1202 may semi-persistently schedule sidelink communication resources that include a first set 1206-a and a second set 1206-b of communication resources in PSSCH for each sidelink slot. SCI 1202 may also semi-persistently schedule sidelink sensing resources that include a first sensing resource 1208-a and second sensing resource 1208-b in PSSCH for each sidelink slot. As described herein, the first sensing resource 1208-a and/or the second sensing resource 1208-b may include one or more guard periods or symbols.

In some examples, UE 1104-e may format the SCI to dynamically schedule sidelink communication resources and semi-persistently schedule sidelink sensing resources. For example, with reference to the slot structure of FIG. 6B, UE 1104-e may format an SCI to indicate that the 6 symbols of PSSCH for a first sidelink slot are dynamically scheduled as sidelink communication resources. UE 1104-e may also format the SCI to indicate that the gap symbol 652 after the PSSCH and the gap symbol 654 after the PSFCH for the first sidelink slot and each sidelink slot thereafter are semi-persistently scheduled as sidelink sensing resources. That is, for example, UE 1104-e may transmit the SCI indicating the dynamically scheduled sidelink communication resources and the semi-persistently scheduled sidelink sensing resources to UE 1104-c.

As an additional example and as illustrated in example SCI scenario 1200-b of FIG. 12B, UE 1104-c may format SCI 1212 and transmit SCI 1212 on PSCCH. SCI 1212 may indicate a reservation 1214 that includes a dynamic scheduling of sidelink communication resources and a semi-persistent scheduling of sidelink sensing resources. That is, for example, SCI 1212 may dynamically schedule sidelink communication resources that include a first set 1206-a and a second set 1206-b of communication resources in PSSCH for a first sidelink slot ending at a first slot boundary 1210. SCI 1212 may also semi-persistently schedule sidelink sensing resources that include a first sensing resource 1208-a and second sensing resource 1208-b in PSSCH for the first sidelink slot and each sidelink slot thereafter in accordance with SCI 1212. In some examples, the semi-persistently scheduled first sensing resource 1208-a and/or the second sensing resource 1208-b may be indicated for bistatic sensing in SCI 1212. UE 1104-c receiving SCI 1212 may serve as the sidelink sensing receiving UE. That is, for example, UE 1104-c may cooperatively join in the bistatic sensing procedure with UE 1104-e as the sidelink sensing transmitting UE.

In some cases, UE 1104-c may not receive or properly decode SCI 1212. As illustrated in example SCI scenario 1200-c of FIG. 12C, UE 1104-e may format a subsequent SCI 1222 and transmit SCI 1222 on PSCCH, for example, at some time after the first slot boundary 1210 when UE 1104e determines that UE 1104-c did not receive SCI 1212. In some examples, the subsequent SCI 1222 may be transmitted on PSCCH by UE 1104-c indicating a reservation 1224 that includes the dynamically scheduled sidelink communication resources and the semi-persistently scheduled sidelink sensing resources to UE 1104-c. That is, for example, SCI 1222 may dynamically schedule sidelink communication resources that include a first set 1206-a and a second set 1206-b of communication resources in PSSCH for a second sidelink slot ending at a second slot boundary 1220. SCI 1222 may also semi-persistently schedule sidelink sensing resources that include a first sensing resource 1208-a and second sensing resource 1208-b in PSSCH for the second sidelink slot and each sidelink slot thereafter in accordance with SCI 1222. In this way, if UE 1104-c did not receive the SCI 1212 initially transmitted by UE 1104-e but receives the subsequent SCI 1222, UE 1104-c may be able to join in the bistatic sensing procedure with UE 1104-e after UE 1104-e begins the sensing procedure associated with the sensing instructions indicated in SCI 1212. That is, for example, UE 1104-e may also be performing a monostatic sensing procedure (e.g., as illustrated in the example of FIG. 9A) in conjunction with the bistatic sensing procedure and may be able to include the results of the monostatic sensing procedure (e.g., using the first sensing resource 1208-a) from the first sidelink slot ending at the first slot boundary 1210 with the results of the monostatic sensing procedure and the bistatic sensing procedure from the second sidelink slot ending at the second slot boundary 1220 and subsequent sidelink slots into a combined report.

In some examples, a UE transmitting an SCI that reserves sidelink sensing resource(s) (e.g., UE 1104-d or 1104-e) may not know whether the corresponding sidelink device is capable of or configured to perform sidelink sensing operations. Additionally, or alternatively, a UE transmitting an SCI that reserves sidelink communication resource(s) and sidelink sensing resource(s) (e.g., UE 1104-c) may not know whether the corresponding sidelink device is capable of or configured to perform sidelink communication operations and sidelink sensing operations.

In accordance with some aspects, UE 1104 receiving the SCI may process the SCI based on its RF capability type. For example, UE 1104-e may transmit an SCI that includes a sidelink allocation to another UE 1104 in JCS system 1100. The sidelink allocation may indicate a set of sidelink resources from the sidelink resource pool(s) and may indicate sidelink communication resource(s), sidelink sensing resource(s), or both associated with the set of sidelink resources.

In some examples, a UE 1104 may receive an SCI from any other UE 1104 in the JCS system 1100. In some cases, neither the UE 1104 transmitting the SCI nor the UE 1104 receiving the SCI may be aware of the RF capability type of the other UE. As such, the UE 1104 receiving the SCI may behave in a manner different from that which the UE 1104 transmitting the SCI intended. Additionally, or alternatively, the UE 1104 transmitting the SCI may transmit to a group of UEs 1104, some of which may have different RF capability types and behave differently to the information in the SCI. For example, UE 1104-a may receive, from UE 1104-e via link 1192, an SCI for sidelink sensing resource reservation. The SCI may include sidelink sensing resource(s), and UE 1104-a may not itself transmit another SCI to reserve sidelink communication resources corresponding to the resources that are part of the sidelink sensing resource reservation. That is, for example, if the sidelink sensing resource(s) indicated in the SCI transmitted by UE 1104-e are sidelink resources that could otherwise have been used for communication purposes, then UE 1104-a should refrain from scheduling and using those sidelink sensing resource(s) for communication with another UE. Additionally, UE 1104-a may refrain from monitoring the signals in those sidelink sensing resource(s) (e.g., because UE 1104-a is a communication-only type and its RF components are configured for communication purposes and not for sensing).

In some examples, UE 1104-a may receive, from UE 1104-e via link 1192, an SCI for sidelink communication and sensing resource reservation (e.g., a JCS resource reservation). The SCI may include both sidelink communication resource(s) and sidelink sensing resource(s), and UE 1104-a may not itself transmit another SCI to reserve sidelink communication resources corresponding to the resources that are part of the sidelink communication and sensing resource reservation. That is, for example, if the sidelink communication resource(s) or the sidelink sensing resource(s) indicated in the SCI transmitted by UE 1104-e are sidelink resources that are used for or could otherwise have been used for communication purposes, then UE 1104-a should refrain from scheduling and using those sidelink sensing resource(s) for communication with another UE. Additionally, UE 1104-a may monitor the signals in the sidelink communication resource(s). That is, for example, UE 1104-a may monitor the signaling for ACG, DMRS, PSCCH, PSSCH, PSFCH, etc. associated with the sidelink communication resource(s) indicated in the SCI. UE 1104-a may use the sidelink sensing resource(s) indicated in the SCI monitor as guard periods.

In some examples, UE 1104-b may receive, from UE 1104-e via link 1192, an SCI for sidelink communication resource reservation. The SCI may include sidelink communication resource(s), and UE 1104-b may not itself transmit another SCI to reserve sidelink sensing resources corresponding to the resources that are part of the sidelink communication resource reservation. That is, for example, if the sidelink communication resource(s) indicated in the SCI transmitted by UE 1104-e are sidelink resources that could otherwise have been used for sensing purposes (e.g., a sideling resource that may be allocated for either communication or sensing purposes), then UE 1104-b should refrain from scheduling and using those sidelink communication resource(s) for sensing purposes in the JCS system 1100. Additionally, UE 1104-b may refrain from monitoring the signals in those sidelink communication resource(s) (e.g., because UE 1104-b is a sensing-only type and its RF components are configured for sensing purposes and not for communication).

In some examples, UE 1104-b may receive, from UE 1104-e via link 1192, an SCI for sidelink communication and sensing resource reservation (e.g., a JCS resource reservation). The SCI may include both sidelink communication resource(s) and sidelink sensing resource(s), and UE 1104-b may not itself transmit another SCI to reserve sidelink sensing resources corresponding to the resources that are part of the sidelink communication and sensing resource reservation. That is, for example, if the sidelink communication resource(s) or the sidelink sensing resource(s) indicated in the SCI transmitted by UE 1104-e are sidelink resources that are used for communication or sensing purposes, then UE 1104-b should refrain from scheduling and using those sidelink resource(s) for sensing purposes either on its own (e.g., monostatic sensing) or in cooperation with another UE (e.g., bistatic sensing). However, UE 1104-b may monitor the signals (e.g., sensing RS) transmitted in the sidelink sensing resource(s) indicated in the SCI.

In some examples, UE 1104-c may receive, from UE 1104-e via link 1192, an SCI for sidelink communication reservation. The SCI may include sidelink communication resource(s), and UE 1104-c may not itself transmit another SCI to reserve sidelink communication resources corresponding to the resources that are part of the sidelink communication reservation. Additionally, UE 1104-c may monitor the signals in the sidelink communication resource(s). That is, for example, UE 1104-c may monitor the signaling for ACG, DMRS, PSCCH, PSSCH, PSFCH, etc. associated with the sidelink communication resource(s) indicated in the SCI.

In some examples, UE 1104-c may receive, from UE 1104-e via link 1192, an SCI for sidelink sensing resource reservation. The SCI may include sidelink sensing resource(s), and UE 1104-c may not itself transmit another SCI to reserve sidelink resources corresponding to the resources that are part of the sidelink sensing resource reservation. That is, for example, absent instructions from UE 1104-e to perform a sensing procedure, UE 1104-c should refrain from scheduling and using the sidelink sensing resource(s) for sensing purposes either on its own (e.g., monostatic sensing) or in cooperation with another UE (e.g., bistatic sensing). However, UE 1104-c may monitor the signals (e.g., sensing RS) transmitted in the sidelink sensing resource(s) indicated in the SCI.

In some examples, UE 1104-c may receive, from UE 1104-e via link 1192, an SCI for sidelink communication and sensing resource reservation (e.g., a JCS resource reservation). The SCI may include both sidelink communication resource(s) and sidelink sensing resource(s), and UE 1104-c may not itself transmit another SCI to reserve sidelink resources corresponding to the resources that are part of the sidelink communication and sensing resource reservation. That is, for example, absent instructions from UE 1104-e to communicate with or perform a sensing procedure, UE 1104-c should refrain from scheduling and using the sidelink communication resource(s) to communicate with another UE. Additionally, UE 1104-c should refrain from scheduling and using the sidelink sensing resource(s) for sensing purposes either on its own (e.g., monostatic sensing) or in cooperation with another UE (e.g., bistatic sensing). However, as UE 1104-c may include multiple sets of RF components, UE 1104-c may monitor the signals in the sidelink communication resource(s) via a first set of RF components. That is, for example, UE 1104-c may monitor the signaling for ACG, DMRS, PSCCH, PSSCH, PSFCH, etc. associated with the sidelink communication resource(s) indicated in the SCI. Additionally, UE 1104-c may monitor the signals (e.g., sensing RS) transmitted in the sidelink sensing resource(s) indicated in the SCI via a second set of RF components.

In accordance with some aspects, a UE 1104 may indicate in the SCI that the reserved sidelink sensing resource(s) (e.g., in sensing resource reservation or a JCS resource reservation) are to be used for monostatic sensing, bistatic sensing, or both. For example, with reference to FIG. 9A, UE 1104-e as the sensing Tx and Rx device may perform a monostatic sensing procedure. UE 1104-e may transmit, via communication link 1120, a sensing report corresponding to the results of the monostatic sensing procedure to base station 1102. In some cases, base station 1102 may forward the sensing report to another network entity, such as a sensing server or location server in the core network. (e.g., 5GC)

In some examples, with reference to FIG. 9B, UE 1104-e as the sensing Tx device may transmit an SCI that includes sidelink sensing resource(s) to UE 1104-c as the sensing Rx device. That is, for example, UE 1104-e may perform a bistatic sensing procedure in cooperation with UE 1104-c. UE 1104-e may indicate in the SCI or otherwise that UE 1104-c is to transmit a sensing report corresponding to the bistatic sensing procedure to the network. UE 1104-c and UE 1104-c may perform the bistatic sensing procedure, and UE 1104-c may transmit, via communication link 1120, a sensing report corresponding to the results of the bistatic sensing procedure to base station 1102. In some cases, base station 1102 may forward the sensing report to another network entity, such as a sensing server or location server in the core network.

In some examples, with reference to FIG. 9B, UE 1104-e as the sensing Tx device may transmit an SCI that includes sidelink sensing resource(s) to UE 1104-c as the sensing Rx device. That is, for example, UE 1104-e may perform a bistatic sensing procedure in cooperation with UE 1104-c. UE 1104-e may indicate in the SCI or otherwise that UE 1104-c is to transmit a sensing report corresponding to the bistatic sensing procedure back to UE 1104-c. UE 1104-e and UE 1104-c may perform the bistatic sensing procedure, and UE 1104-c may transmit, via link 1192, a sensing report corresponding to the results of the bistatic sensing procedure to UE 1104-c. UE 1104-e may then transmit, via communication link 1120, the sensing report received from UE 1104-c to base station 1102. In some cases, base station 1102 may forward the sensing report to another network entity, such as a sensing server or location server in the core network (e.g., 5GC).

In some examples, with reference to FIGS. 9A and 9B, UE 1104-e as the sensing Tx and Rx device with respect a monostatic sensing procedure may perform the monostatic sensing procedure. Additionally, UE 1104-e as the sensing Tx device with respect to a bistatic sensing procedure may transmit an SCI that includes sidelink sensing resource(s) to UE 1104-c as the sensing Rx device. UE 1104-e may perform the bistatic sensing procedure in cooperation with UE 1104-c. UE 1104-e may indicate in the SCI or otherwise that UE 1104-c is to transmit a sensing report corresponding to the bistatic sensing procedure back to UE 1104-c. UE 1104-e and UE 1104-c may perform the bistatic sensing procedure, and UE 1104-c may transmit, via link 1192, a sensing report corresponding to the results of the bistatic sensing procedure to UE 1104-e. UE 1104-c may combine the monostatic sensing report and the bistatic sensing report received from UE 1104-c into a combined sensing report. UE 1104-e may then transmit, via communication link 1120, the combined sensing report to base station 1102. In some cases, base station 1102 may forward the combined sensing report to another network entity, such as a sensing server or location server in the core network (e.g., 5GC).

In some examples, with reference to FIGS. 9A and 9B, UE 1104-e as the sensing Tx and Rx device with respect a monostatic sensing procedure may perform the monostatic sensing procedure. Additionally, UE 1104-e as the sensing Tx device with respect to a bistatic sensing procedure may transmit an SCI that includes sidelink sensing resource(s) to UE 1104-c as the sensing Rx device. That is, UE 1104-e may perform the bistatic sensing procedure in cooperation with UE 1104-c. UE 1104-e may indicate in the SCI or otherwise that UE 1104-c is to combine a sensing report corresponding to the monostatic sensing procedure and a sensing report corresponding to the bistatic sensing procedure. UE 1104-c may further indicate in the SCI or otherwise that UE 1104-c is to transmit the combined report to the network. UE 1104-e and UE 1104-c may perform the bistatic sensing procedure. UE 1104-e may transmit, via link 1192, the sensing report corresponding to the results of the monostatic sensing procedure to UE 1104-c. UE 1104-c may combine the monostatic sensing report received from UE 1104-e and a bistatic sensing report into a combined sensing report. UE 1104-c may then transmit, via communication link 1120, the combined sensing report to base station 1102. In some cases, base station 1102 may forward the combined sensing report to another network entity, such as a sensing server or location server in the core network (e.g., 5GC).

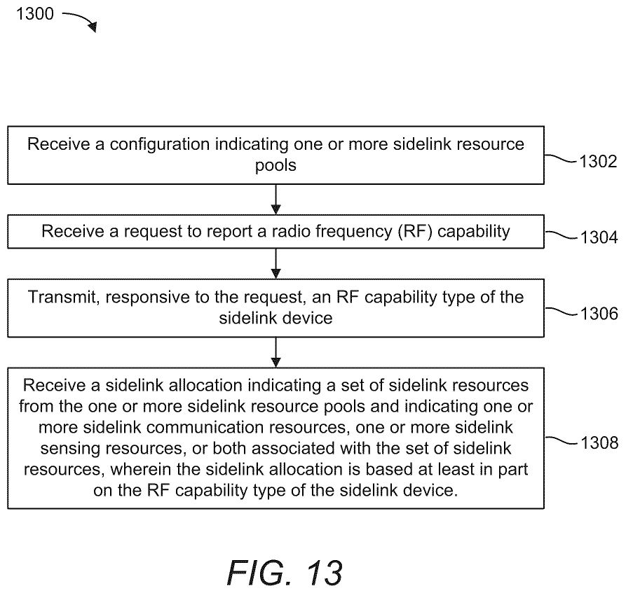

FIG. 13 is a flowchart illustrating an example method 1300 associated with techniques for joint communication and sensing in sidelink, according to aspects of the disclosure. In some implementations, one or more aspects of FIG. 13 may be performed by a sidelink device (e.g., UE 1004, UE 1104, or any of the UEs described herein). In some implementations, one or more aspects of FIG. 13 may be performed by another device or a group of devices separate from or including the sidelink device. Additionally, or alternatively, one or more aspects of FIG. 13 may be performed by one or more components of an apparatus, such as a processor(s), memory, or transceiver(s), any or all of which may be means for performing the operations of method 1300.

As shown in FIG. 13, method 1300 may include, at 1302, receiving a configuration indicating one or more sidelink resource pools. Means for performing these operation(s) may include the processor(s), memory, or transceiver(s) of any of the apparatus or devices described herein. For example, the sidelink device may receive a configuration indicating one or more sidelink resource pools, using WWAN transceivers 310.

As further shown in FIG. 13, method 1300 may include, at 1304, receiving a request to report an RF capability. Means for performing these operation(s) may include the processor(s), memory, or transceiver(s) of any of the apparatus described herein. For example, the sidelink device may receive a request to report a RF capability, using WWAN transceivers 310.

As further shown in FIG. 13, method 1300 may include, at 1306, transmitting, responsive to the request, an RF capability type of the sidelink device. Means for performing these operation(s) may include the processor(s), memory, or transceiver(s) of any of the apparatus or devices described herein. For example, the sidelink device may transmit, responsive to the request, an RF capability type of the sidelink device, using WWAN transceivers 310.

As further shown in FIG. 13, method 1300 may include, at 1308, receiving a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device. Means for performing these operation(s) may include the processor(s), memory, or transceiver(s) of any of the apparatus or devices described herein. For example, the sidelink device may receive a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device, using WWAN transceivers 310.

Method 1300 may include additional implementations, such as any single implementation or any combination of implementations described below and/or in connection with one or more other aspects described elsewhere herein.

In some aspects, the sidelink allocation comprises the one or more sidelink communication resources absent any indication of a sidelink sensing resource based at least in part on the RF capability type of the sidelink device being a communication-only type.

In some aspects, the sidelink allocation comprises the one or more sidelink sensing resources absent any indication of a sidelink communication resource based at least in part on the RF capability type of the sidelink device being a sensing-only type. In some aspects, the one or more sidelink sensing resources comprise a last symbol of sidelink slot.

In some aspects, the sidelink allocation comprises the one or more sidelink communication resources and the one or more sidelink sensing resources based at least in part on the RF capability type of the sidelink device being a joint communication and sensing type.

In some aspects, method 1300 includes transmitting a communication scheduling request and a sensing scheduling request in a first UCI via a first PUCCH.

In some aspects, method 1300 includes encoding a communication scheduling request in a first UCI, encoding a sensing scheduling request in a second UCI different from the first UCI, transmitting the first UCI via a first PUCCH, and transmitting the second UCI via a second PUCCH.

In some aspects, the sidelink allocation is received as a DCI via a PDCCH.

In some aspects, the sidelink allocation is received as a first DCI via a first PDCCH and a second DCI via a second PDCCH different from the first PDCCH.

In some aspects, the one or more sidelink sensing resources comprise one or more guard periods associated with the one or more sidelink communication resources.

Although FIG. 13 shows example operations of method 1300, in some implementations, method 1300 may include additional operations, fewer operations, different operations, or differently arranged operations than those depicted in FIG. 13. Additionally, or alternatively, two or more of the operations of method 1300 may be performed in parallel. As will be appreciated, a technical advantage of the method 1300 is enabling the network to more efficiently assign sidelink resources to UEs in a JCS system.

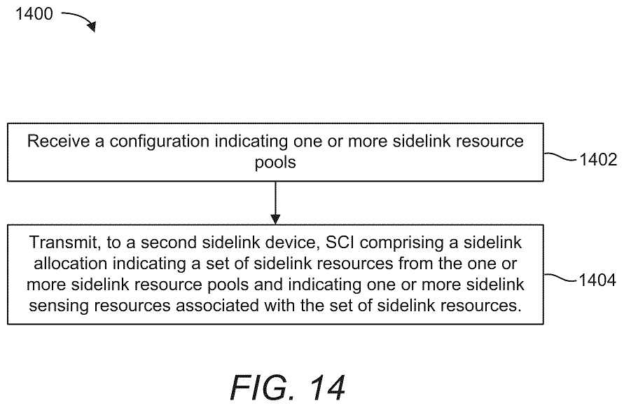

FIG. 14 is a flowchart illustrating an example method 1400 associated with techniques for joint communication and sensing in sidelink, according to aspects of the disclosure. In some implementations, one or more aspects of FIG. 14 may be performed by a first sidelink device (e.g., UE 1004, UE 1104, or any of the UEs described herein). In some implementations, one or more aspects of FIG. 14 may be performed by another device or a group of devices separate from or including the first sidelink device. Additionally, or alternatively, one or more aspects of FIG. 14 may be performed by one or more components of an apparatus, such as a processor(s), memory, or transceiver(s), any or all of which may be means for performing the operations of method 1400.

As shown in FIG. 14, method 1400 may include, at 1402, receiving a configuration indicating one or more sidelink resource pools. Means for performing these operation(s) may include the processor(s), memory, or transceiver(s) of any of the apparatus or devices described herein. For example, the first sidelink device may receive a configuration indicating one or more sidelink resource pools, using WWAN transceivers 310.

As further shown in FIG. 14, method 1400 may include, at 1404, transmitting, to a second sidelink device, SCI comprising a sidelink allocation indicating a set of sidelink resources from the one or more sidelink resource pools and indicating one or more sidelink sensing resources associated with the set of sidelink resources. Means for performing these operation(s) may include the processor(s), memory, or transceiver(s) of any of the apparatus or devices described herein. For example, the first sidelink device may transmit, to a second sidelink device. SCI comprising a sidelink allocation indicating a set of sidelink resources from the one or more sidelink resource pools and indicating one or more sidelink sensing resources associated with the set of sidelink resources, using WWAN transceivers 310.

Method 1400 may include additional implementations, such as any single implementation or any combination of implementations described below and/or in connection with one or more other aspects described elsewhere herein.

In some aspects, the one or more sidelink resource pools comprises a sidelink sensing resource pool.

In some aspects, the one or more sidelink resource pools comprises a joint sidelink communication and sensing resource pool.

In some aspects, method 1400 includes receiving, from a network entity, an indication that a last symbol of a sidelink slot is configured to be reserved by the first sidelink device as the one or more sidelink sensing resources.

In some aspects, method 1400 includes determining that the one or more sidelink sensing resources are to be used for bistatic sensing, and formatting, based at least in part on the determining, the SCI format to include control information of a sensing waveform associated with the one or more sidelink sensing resources.

In some aspects, the sidelink allocation indicates one or more sidelink communication resources associated with the set of sidelink resources.

In some aspects, the SCI comprises a semi-persistent scheduling of the one or more sidelink communication resources and a semi-persistent scheduling of the one or more sidelink communication resources.

In some aspects, the SCI comprises a dynamic scheduling of the one or more sidelink communication resources and a semi-persistent scheduling of the one or more sidelink communication resources.

In some aspects, the SCI comprises an indication of a sensing procedure associated with the one or more sidelink sensing resources.

In some aspects, method 1400 includes performing a monostatic sensing procedure, and transmitting, to a network entity, a report associated with the monostatic sensing procedure.

In some aspects, method 1400 includes performing a bistatic sensing procedure cooperative with the second sidelink device.

In some aspects, the SCI comprises an indication for the second sidelink device to transmit a report associated with the bistatic sensing procedure to at least one of a network entity or the first sidelink device.

In some aspects, method 1400 includes performing a monostatic sensing procedure and a bistatic sensing procedure cooperative with the second sidelink device.

In some aspects, the SCI comprises an indication for the second sidelink device to transmit a first report associated with the bistatic sensing procedure to the first sidelink device.

In some aspects, method 1400 includes receiving the first report associated with the bistatic sensing procedure, combining a second report associated with the monostatic sensing procedure with the first report associated with the bistatic sensing procedure, and transmitting, to a network entity, a combined report associated with the monostatic sensing procedure and the bistatic sensing procedure.

In some aspects, method 1400 includes transmitting a report associated with the monostatic sensing procedure to the second sidelink device.

In some aspects, the SCI format comprises an indication for the second sidelink device to transmit a combined report associated with the monostatic sensing procedure and the bistatic sensing procedure.

Although FIG. 14 shows example operations of method 1400, in some implementations, method 1400 may include additional operations, fewer operations, different operations, or differently arranged operations than those depicted in FIG. 14. Additionally, or alternatively, two or more of the operations of method 1400 may be performed in parallel. As will be appreciated, a technical advantage of the method 1400 is enabling a UE to transmit an indication that guard periods or guard symbols in a sidelink slot are to be used as sidelink sensing resources in a JCS system.

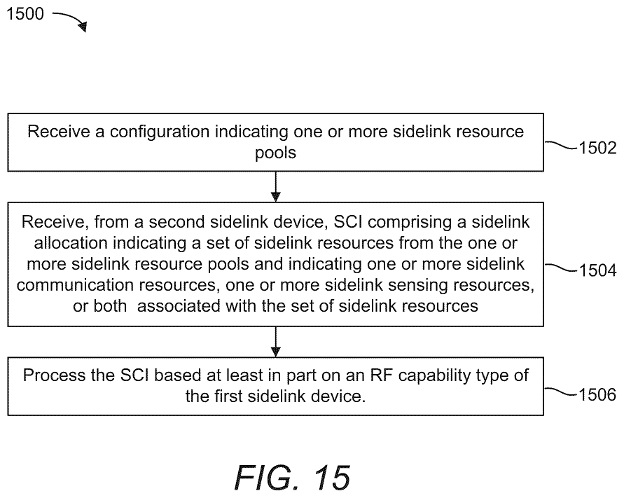

FIG. 15 is a flowchart illustrating an example method 1500 associated with techniques for joint communication and sensing in sidelink, according to aspects of the disclosure. In some implementations, one or more aspects of FIG. 15 may be performed by a first sidelink device (e.g., UE 1004, UE 1104, or any of the UEs described herein). In some implementations, one or more aspects of FIG. 15 may be performed by another device or a group of devices separate from or including the first sidelink device. Additionally, or alternatively, one or more aspects of FIG. 15 may be performed by one or more components of an apparatus, such as a processor(s), memory, or transceiver(s), any or all of which may be means for performing the operations of method 1500.

As shown in FIG. 15, method 1500 may include, at 1502, receiving a configuration indicating one or more sidelink resource pools. Means for performing these operation(s) may include the processor(s), memory, or transceiver(s) of any of the apparatus or devices described herein. For example, the first sidelink device may receive a configuration indicating one or more sidelink resource pools, using WWAN transceivers 310.

As further shown in FIG. 15, method 1500 may include, at 1504, receiving, from a second sidelink device, SCI comprising a sidelink allocation indicating a set of sidelink resources from the one or more sidelink resource pools and indicating one or more sidelink communication resources, one or more sidelink sensing resources, or both associated with the set of sidelink resources. Means for performing these operation(s) may include the processor(s), memory, or transceiver(s) of any of the apparatus or devices described herein. For example, the first sidelink device may receive, from a second sidelink device, SCI comprising a sidelink allocation indicating a set of sidelink resources from the one or more sidelink resource pools and indicating one or more sidelink communication resources, one or more sidelink sensing resources, or both associated with the set of sidelink resources, using WWAN transceivers 310.

As further shown in FIG. 15, method 1500 may include, at 1506, processing the SCI based at least in part on an RF capability type of the first sidelink device. Means for performing these operation(s) may include the processor(s), memory, or transceiver(s) of any of the apparatus or devices described herein. For example, the first sidelink device may processing the SCI based at least in part on an RF capability type of the first sidelink device, using one or more processors 332. Method 1500 may include additional implementations, such as any single implementation or any combination of implementations described below and/or in connection with one or more other aspects described elsewhere herein.

In some aspects, the sidelink allocation comprises the one or more sidelink sensing resources.

In some aspects, method 1500 includes refraining, based at least in part on the RF capability type of the first sidelink device being a communication-only type, from transmitting SCI for reserving sidelink communication resources in the set of sidelink resources, and refraining, based at least in part on the RF capability type of the first sidelink device being the communication-only type, from monitoring signals corresponding to the one or more sidelink sensing resources.

In some aspects, method 1500 includes refraining, based at least in part on the RF capability type of the first sidelink device being a joint communication and sensing type, from transmitting SCI for reserving sidelink resources in the set of sidelink resources, and monitoring, based at least in part on the RF capability type of the first sidelink device being the joint communication and sensing type, signals corresponding to the one or more sidelink sensing resources.

In some aspects, the sidelink allocation comprises the one or more sidelink communication resources.

In some aspects, method 1500 includes refraining, based at least in part on the RF capability type of the first sidelink device being a sensing-only type, from transmitting SCI for reserving sidelink sensing resources in the set of sidelink resources, and refraining, based at least in part on the RF capability type of the first sidelink device being the sensing-only type, from monitoring signals corresponding to the one or more sidelink communication resources.

In some aspects, method 1500 includes refraining, based at least in part on the RF capability type of the first sidelink device being a joint communication and sensing type, from transmitting SCI for reserving sidelink resources in the set of sidelink resources, and monitoring, based at least in part on the RF capability type of the first sidelink device being the joint communication and sensing type, signals corresponding to the one or more sidelink communication resources.

In some aspects, the sidelink allocation comprises the one or more sidelink communication resources and the one or more sidelink sensing resources.

In some aspects, method 1500 includes monitoring, based at least in part on the RF capability type of the first sidelink device being a communication-only type, signals corresponding to the sidelink communication sensing resource, and using, based at least in part on the RF capability type of the first sidelink device being the communication-only type, the one or more sidelink sensing resources as one or more guard periods.

In some aspects, method 1500 includes refraining, based at least in part on the RF capability type of the first sidelink device being a sensing-only type, from transmitting SCI for reserving sidelink sensing resources in the set of sidelink resources, and monitoring, based at least in part on the RF capability type of the first sidelink device being the sensing-only type, signals corresponding to the one or more sidelink sensing resources.

In some aspects, method 1500 includes refraining, based at least in part on the RF capability type of the first sidelink device being a joint communication and sensing type, from transmitting SCI for reserving sidelink resources in the set of sidelink resources, monitoring, via a first set of RF components and based at least in part on the RF capability type of the first sidelink device being the joint communication and sensing type, signals corresponding to the one or more sidelink communication resources, and monitoring, via a second set of RF components different from the first set of RF components and based at least in part on the RF capability type of the first sidelink device being the joint communication and sensing type, signals corresponding to the one or more sidelink sensing resources.

In some aspects, the SCI comprises a first indication of a bistatic sensing procedure associated with the one or more sidelink sensing resources, and wherein the SCI comprises a second indication for the first sidelink device to transmit a report associated with the bistatic sensing procedure to at least one of a network entity or the second sidelink device.

In some aspects, method 1500 includes performing, based at least in part on the first indication in the SCI, the bistatic sensing procedure cooperative with the second sidelink device, and transmitting, based at least in part on the second indication in the SCI, the report associated with the bistatic sensing procedure.

In some aspects, the SCI comprises a first indication of a monostatic sensing procedure and a bistatic sensing procedure associated with the one or more sidelink sensing resources, and wherein the SCI comprises a second indication for the first sidelink device to transmit a combined report associated with the monostatic sensing procedure and the bistatic sensing procedure.

In some aspects, method 1500 includes performing, based at least in part on the first indication in the SCI, the bistatic sensing procedure cooperative with the second sidelink device, receiving, from the second sidelink device, a report associated with the monostatic sensing procedure, combining a report associated with the monostatic sensing procedure and a report associated with the bistatic sensing procedure, and transmitting, based at least in part on the second indication in the SCI, the combined report associated with the monostatic sensing procedure and the bistatic sensing procedure.

Although FIG. 15 shows example operations of method 1500, in some implementations, method 1500 may include additional operations, fewer operations, different operations, or differently arranged operations than those depicted in FIG. 15. Additionally, or alternatively, two or more of the operations of method 1500 may be performed in parallel.

As will be appreciated, a technical advantage of the method 1500 is enabling a UE receiving an indication of a sidelink resource reservation to behave in an efficient and predictable manner when operating in a JCS system.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a sidelink device, comprising: receiving a configuration indicating one or more sidelink resource pools; receiving a request to report a radio frequency (RF) capability; transmitting, responsive to the request, an RF capability type of the sidelink device; and receiving a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

Clause 2. The method of clause 1, wherein the sidelink allocation comprises the one or more sidelink communication resources absent any indication of a sidelink sensing resource based at least in part on the RF capability type of the sidelink device being a communication-only type.

Clause 3. The method of any of clauses 1 to 2, wherein: the sidelink allocation comprises the one or more sidelink sensing resources absent any indication of a sidelink communication resource based at least in part on the RF capability type of the sidelink device being a sensing-only type; and the one or more sidelink sensing resources comprise a last symbol of sidelink slot.

Clause 4. The method of any of clauses 1 to 3, wherein: the sidelink allocation comprises the one or more sidelink communication resources and the one or more sidelink sensing resources based at least in part on the RF capability type of the sidelink device being a joint communication and sensing type; and the one or more sidelink sensing resources comprise one or more guard periods associated with the one or more sidelink communication resources.

Clause 5. The method of clause 4, further comprising: transmitting a communication scheduling request and a sensing scheduling request in a first uplink control information (UCI) via a first physical uplink control channel (PUCCH).

Clause 6. The method of any of clauses 4 to 5, further comprising: encoding a communication scheduling request in a first uplink control information (UCI); encoding a sensing scheduling request in a second UCI different from the first UCI; transmitting the first UCI via a first physical uplink control channel (PUCCH); and transmitting the second UCI via a second PUCCH.

Clause 7. The method of clause 6, wherein the sidelink allocation is received as a downlink control information (DCI) via a physical downlink control channel (PDCCH).

Clause 8. The method of any of clauses 6 to 7, wherein the sidelink allocation is received as a first downlink control information (DCI) via a first physical downlink control channel (PDCCH) and a second DCI via a second PDCCH different from the first PDCCH.

Clause 9. A method of wireless communication performed by a first sidelink device, comprising: receiving a configuration indicating one or more sidelink resource pools; and transmitting, to a second sidelink device, sidelink control information (SCI) comprising a sidelink allocation indicating a set of sidelink resources from the one or more sidelink resource pools and indicating one or more sidelink sensing resources associated with the set of sidelink resources.

Clause 10. The method of clause 9, wherein the one or more sidelink resource pools comprise a sidelink sensing resource pool or a joint sidelink communication and sensing resource pool.

Clause 11. The method of any of clauses 9 to 10, further comprising: receiving, from a network entity, an indication that a last symbol of a sidelink slot is configured to be reserved by the first sidelink device as the one or more sidelink sensing resources.

Clause 12. The method of any of clauses 9 to 11, further comprising: determining that the one or more sidelink sensing resources are to be used for bistatic sensing; and formatting, based at least in part on the determining, the SCI format to include control information of a sensing waveform associated with the one or more sidelink sensing resources.

Clause 13. The method of any of clauses 9 to 12, wherein the sidelink allocation indicates one or more sidelink communication resources associated with the set of sidelink resources.

Clause 14. The method of clause 13, wherein: the SCI comprises a semi-persistent scheduling of the one or more sidelink communication resources and a semi-persistent scheduling of the one or more sidelink communication resources; or the SCI comprises a dynamic scheduling of the one or more sidelink communication resources and the semi-persistent scheduling of the one or more sidelink communication resources.

Clause 15. The method of any of clauses 10 to 14, wherein the SCI comprises an indication of a sensing procedure associated with the one or more sidelink sensing resources.

Clause 16. The method of any of clauses 10 to 15, further comprising: performing a monostatic sensing procedure; and transmitting, to a network entity, a report associated with the monostatic sensing procedure.

Clause 17. The method of any of clauses 10 to 16, further comprising: performing a bistatic sensing procedure cooperative with the second sidelink device, and wherein the SCI comprises an indication for the second sidelink device to transmit a report associated with the bistatic sensing procedure to at least one of a network entity or the first sidelink device.

Clause 18. The method of any of clauses 10 to 17, further comprising: performing a monostatic sensing procedure and a bistatic sensing procedure cooperative with the second sidelink device.

Clause 19. The method of clause 18, wherein the SCI comprises an indication for the second sidelink device to transmit a first report associated with the bistatic sensing procedure to the first sidelink device, and the method further comprising: receiving the first report associated with the bistatic sensing procedure; combining a second report associated with the monostatic sensing procedure with the first report associated with the bistatic sensing procedure; and transmitting, to a network entity, a combined report associated with the monostatic sensing procedure and the bistatic sensing procedure.

Clause 20. The method of any of clauses 18 to 19, further comprising: transmitting a report associated with the monostatic sensing procedure to the second sidelink device, and wherein the SCI comprises an indication for the second sidelink device to transmit a combined report associated with the monostatic sensing procedure and the bistatic sensing procedure.

Clause 21. A method of wireless communication performed by a first sidelink device, comprising: receiving a configuration indicating one or more sidelink resource pools; receiving, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and processing the SCI based at least in part on a radio frequency (RF) capability type of the first sidelink device.

Clause 22. The method of clause 21, wherein the sidelink allocation comprises the one or more sidelink sensing resources, and the method further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink sensing resources.

Clause 23. The method of any of clauses 21 to 22, wherein the sidelink allocation comprises the one or more sidelink communication resources.

Clause 24. The method of clause 23, further comprising: refraining, based at least in part on the RF capability type of the first sidelink device being a sensing-only type, from transmitting SCI for reserving sidelink sensing resources in the set of sidelink resources; and refraining, based at least in part on the RF capability type of the first sidelink device being the sensing-only type, from monitoring signals corresponding to the one or more sidelink communication resources.

Clause 25. The method of any of clauses 23 to 24, further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink communication resources.

Clause 26. The method of any of clauses 21 to 25, wherein the sidelink allocation comprises the one or more sidelink communication resources and the one or more sidelink sensing resources, and the method further comprising: refraining, based at least in part on the RF capability type of the first sidelink device being a joint communication and sensing type, from transmitting SCI for reserving sidelink resources in the set of sidelink resources; monitoring, via a first set of RF components and based at least in part on the RF capability type of the first sidelink device being the joint communication and sensing type, signals corresponding to the one or more sidelink communication resources; and monitoring, via a second set of RF components different from the first set of RF components and based at least in part on the RF capability type of the first sidelink device being the joint communication and sensing type, signals corresponding to the one or more sidelink sensing resources.

Clause 27. The method of any of clauses 21 to 26, wherein: the SCI comprises a first indication of a bistatic sensing procedure associated with the one or more sidelink sensing resources; and the SCI comprises a second indication for the first sidelink device to transmit a report associated with the bistatic sensing procedure to at least one of a network entity or the second sidelink device, and the method further comprising: performing, based at least in part on the first indication in the SCI, the bistatic sensing procedure cooperative with the second sidelink device; and transmitting, based at least in part on the second indication in the SCI, the report associated with the bistatic sensing procedure.

Clause 28. The method of clause 27, wherein: the SCI comprises a first indication of a monostatic sensing procedure and a bistatic sensing procedure associated with the one or more sidelink sensing resources; and the SCI comprises a second indication for the first sidelink device to transmit a combined report associated with the monostatic sensing procedure and the bistatic sensing procedure, and the method further comprising: performing, based at least in part on the first indication in the SCI, the bistatic sensing procedure cooperative with the second sidelink device; receiving, from the second sidelink device, a report associated with the monostatic sensing procedure; combining the report associated with the monostatic sensing procedure and a report associated with the bistatic sensing procedure; and transmitting, based at least in part on the second indication in the SCI, the combined report associated with the monostatic sensing procedure and the bistatic sensing procedure.

Clause 29. A sidelink device, comprising: one or more memories; one or more transceivers; and one or more processors communicatively coupled to the one or more memories and the one or more transceivers, the one or more processors, either alone or in combination, configured to: receive, via the one or more transceivers, a configuration indicating one or more sidelink resource pools; receive, via the one or more transceivers, a request to report a radio frequency (RF) capability; transmit, via the one or more transceivers, responsive to the request, an RF capability type of the sidelink device; and receive, via the one or more transceivers, a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

Clause 30. The sidelink device of clause 29, wherein the sidelink allocation comprises the one or more sidelink communication resources absent any indication of a sidelink sensing resource based at least in part on the RF capability type of the sidelink device being a communication-only type.

Clause 31. The sidelink device of any of clauses 29 to 30, wherein: the sidelink allocation comprises the one or more sidelink sensing resources absent any indication of a sidelink communication resource based at least in part on the RF capability type of the sidelink device being a sensing-only type; and the one or more sidelink sensing resources comprise a last symbol of sidelink slot.

Clause 32. The sidelink device of any of clauses 29 to 31, wherein: the sidelink allocation comprises the one or more sidelink communication resources and the one or more sidelink sensing resources based at least in part on the RF capability type of the sidelink device being a joint communication and sensing type; and the one or more sidelink sensing resources comprise one or more guard periods associated with the one or more sidelink communication resources.

Clause 33. The sidelink device of clause 32, wherein the one or more processors, either alone or in combination, are further configured to: transmit, via the one or more transceivers, a communication scheduling request and a sensing scheduling request in a first uplink control information (UCI) via a first physical uplink control channel (PUCCH).

Clause 34. The sidelink device of any of clauses 32 to 33, wherein the one or more processors, either alone or in combination, are further configured to: encode a communication scheduling request in a first uplink control information (UCI); encode a sensing scheduling request in a second UCI different from the first UCI; transmit, via the one or more transceivers, the first UCI via a first physical uplink control channel (PUCCH); and transmit, via the one or more transceivers, the second UCI via a second PUCCH.

Clause 35. The sidelink device of clause 34, wherein the sidelink allocation is received as a downlink control information (DCI) via a physical downlink control channel (PDCCH).

Clause 36. The sidelink device of any of clauses 34 to 35, wherein the sidelink allocation is received as a first downlink control information (DCI) via a first physical downlink control channel (PDCCH) and a second DCI via a second PDCCH different from the first PDCCH.

Clause 37. A first sidelink device, comprising: one or more memories; one or more transceivers; and one or more processors communicatively coupled to the one or more memories and the one or more transceivers, the one or more processors, either alone or in combination, configured to: receive, via the one or more transceivers, a configuration indicating one or more sidelink resource pools; and transmit, via the one or more transceivers, to a second sidelink device, sidelink control information (SCI) comprising a sidelink allocation indicating a set of sidelink resources from the one or more sidelink resource pools and indicating one or more sidelink sensing resources associated with the set of sidelink resources.

Clause 38. The first sidelink device of clause 37, wherein the one or more sidelink resource pools comprise a sidelink sensing resource pool or a joint sidelink communication and sensing resource pool.

Clause 39. The first sidelink device of any of clauses 37 to 38, wherein the one or more processors, either alone or in combination, are further configured to: receive, via the one or more transceivers and from a network entity, an indication that a last symbol of a sidelink slot is configured to be reserved by the first sidelink device as the one or more sidelink sensing resources.

Clause 40. The first sidelink device of any of clauses 37 to 39, wherein the one or more processors, either alone or in combination, are further configured to: determine that the one or more sidelink sensing resources are to be used for bistatic sensing; and format, based at least in part on the determining, the SCI format to include control information of a sensing waveform associated with the one or more sidelink sensing resources.

Clause 41. The first sidelink device of any of clauses 37 to 40, wherein the sidelink allocation indicates one or more sidelink communication resources associated with the set of sidelink resources.

Clause 42. The first sidelink device of clause 41, wherein: the SCI comprises a semi-persistent scheduling of the one or more sidelink communication resources and a semi-persistent scheduling of the one or more sidelink communication resources; or the SCI comprises a dynamic scheduling of the one or more sidelink communication resources and the semi-persistent scheduling of the one or more sidelink communication resources.

Clause 43. The first sidelink device of any of clauses 38 to 42, wherein the SCI comprises an indication of a sensing procedure associated with the one or more sidelink sensing resources.

Clause 44. The first sidelink device of any of clauses 38 to 43, wherein the one or more processors, either alone or in combination, are further configured to: perform a monostatic sensing procedure; and transmit, via the one or more transceivers and to a network entity, a report associated with the monostatic sensing procedure.

Clause 45. The first sidelink device of any of clauses 38 to 44, wherein the one or more processors, either alone or in combination, are further configured to: perform a bistatic sensing procedure cooperative with the second sidelink device, and wherein the SCI comprises an indication for the second sidelink device to transmit a report associated with the bistatic sensing procedure to at least one of a network entity or the first sidelink device.

Clause 46. The first sidelink device of any of clauses 38 to 45, wherein the one or more processors, either alone or in combination, are further configured to: perform a monostatic sensing procedure and a bistatic sensing procedure cooperative with the second sidelink device.

Clause 47. The first sidelink device of clause 46, wherein the SCI comprises an indication for the second sidelink device to transmit a first report associated with the bistatic sensing procedure to the first sidelink device, and the method further comprising: receive, via the one or more transceivers, the first report associated with the bistatic sensing procedure; combine a second report associated with the monostatic sensing procedure with the first report associated with the bistatic sensing procedure; and transmit, via the one or more transceivers and to a network entity, a combined report associated with the monostatic sensing procedure and the bistatic sensing procedure.

Clause 48. The first sidelink device of any of clauses 46 to 47, wherein the one or more processors, either alone or in combination, are further configured to: transmit, via the one or more transceivers, a report associated with the monostatic sensing procedure to the second sidelink device, and wherein the SCI comprises an indication for the second sidelink device to transmit a combined report associated with the monostatic sensing procedure and the bistatic sensing procedure.

Clause 49. A first sidelink device, comprising: one or more memories; one or more transceivers; and one or more processors communicatively coupled to the one or more memories and the one or more transceivers, the one or more processors, either alone or in combination, configured to: receive, via the one or more transceivers, a configuration indicating one or more sidelink resource pools; receive, via the one or more transceivers and from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and process the SCI based at least in part on a radio frequency (RF) capability type of the first sidelink device.

Clause 50. The first sidelink device of clause 49, wherein the sidelink allocation comprises the one or more sidelink sensing resources, and the method further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink sensing resources.

Clause 51. The first sidelink device of any of clauses 49 to 50, wherein the sidelink allocation comprises the one or more sidelink communication resources.

Clause 52. The first sidelink device of clause 51, wherein the one or more processors, either alone or in combination, are further configured to: refrain, based at least in part on the RF capability type of the first sidelink device being a sensing-only type, from transmitting SCI for reserving sidelink sensing resources in the set of sidelink resources; and refrain, based at least in part on the RF capability type of the first sidelink device being the sensing-only type, from monitoring signals corresponding to the one or more sidelink communication resources.

Clause 53. The first sidelink device of any of clauses 51 to 52, wherein the one or more processors, either alone or in combination, are further configured to: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink communication resources.

Clause 54. The first sidelink device of any of clauses 49 to 53, wherein the sidelink allocation comprises the one or more sidelink communication resources and the one or more sidelink sensing resources, and the method further comprising: refraining, based at least in part on the RF capability type of the first sidelink device being a joint communication and sensing type, from transmitting SCI for reserving sidelink resources in the set of sidelink resources; monitoring, via a first set of RF components and based at least in part on the RF capability type of the first sidelink device being the joint communication and sensing type, signals corresponding to the one or more sidelink communication resources; and monitoring, via a second set of RF components different from the first set of RF components and based at least in part on the RF capability type of the first sidelink device being the joint communication and sensing type, signals corresponding to the one or more sidelink sensing resources.

Clause 55. The first sidelink device of any of clauses 49 to 54, wherein: the SCI comprises a first indication of a bistatic sensing procedure associated with the one or more sidelink sensing resources; and the SCI comprises a second indication for the first sidelink device to transmit a report associated with the bistatic sensing procedure to at least one of a network entity or the second sidelink device, and the method further comprising: perform, based at least in part on the first indication in the SCI, the bistatic sensing procedure cooperative with the second sidelink device; and transmit, via the one or more transceivers and based at least in part on the second indication in the SCI, the report associated with the bistatic sensing procedure.

Clause 56. The first sidelink device of clause 55, wherein: the SCI comprises a first indication of a monostatic sensing procedure and a bistatic sensing procedure associated with the one or more sidelink sensing resources; and the SCI comprises a second indication for the first sidelink device to transmit a combined report associated with the monostatic sensing procedure and the bistatic sensing procedure, and the method further comprising: perform, based at least in part on the first indication in the SCI, the bistatic sensing procedure cooperative with the second sidelink device; receive, via the one or more transceivers and from the second sidelink device, a report associated with the monostatic sensing procedure; combine the report associated with the monostatic sensing procedure and a report associated with the bistatic sensing procedure; and transmit, via the one or more transceivers and based at least in part on the second indication in the SCI, the combined report associated with the monostatic sensing procedure and the bistatic sensing procedure.

Clause 57. A sidelink device, comprising: means for receiving a configuration indicating one or more sidelink resource pools; means for receiving a request to report a radio frequency (RF) capability; means for transmitting, responsive to the request, an RF capability type of the sidelink device; and means for receiving a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

Clause 58. The sidelink device of clause 57, wherein the sidelink allocation comprises the one or more sidelink communication resources absent any indication of a sidelink sensing resource based at least in part on the RF capability type of the sidelink device being a communication-only type.

Clause 59. The sidelink device of any of clauses 57 to 58, wherein: the sidelink allocation comprises the one or more sidelink sensing resources absent any indication of a sidelink communication resource based at least in part on the RF capability type of the sidelink device being a sensing-only type; and the one or more sidelink sensing resources comprise a last symbol of sidelink slot.

Clause 60. The sidelink device of any of clauses 57 to 59, wherein: the sidelink allocation comprises the one or more sidelink communication resources and the one or more sidelink sensing resources based at least in part on the RF capability type of the sidelink device being a joint communication and sensing type; and the one or more sidelink sensing resources comprise one or more guard periods associated with the one or more sidelink communication resources.

Clause 61. The sidelink device of clause 60, further comprising: means for transmitting a communication scheduling request and a sensing scheduling request in a first uplink control information (UCI) via a first physical uplink control channel (PUCCH).

Clause 62. The sidelink device of any of clauses 60 to 61, further comprising: means for encoding a communication scheduling request in a first uplink control information (UCI); means for encoding a sensing scheduling request in a second UCI different from the first UCI; means for transmitting the first UCI via a first physical uplink control channel (PUCCH); and means for transmitting the second UCI via a second PUCCH.

Clause 63. The sidelink device of clause 62, wherein the sidelink allocation is received as a downlink control information (DCI) via a physical downlink control channel (PDCCH).

Clause 64. The sidelink device of any of clauses 62 to 63, wherein the sidelink allocation is received as a first downlink control information (DCI) via a first physical downlink control channel (PDCCH) and a second DCI via a second PDCCH different from the first PDCCH.

Clause 65. A first sidelink device, comprising: means for receiving a configuration indicating one or more sidelink resource pools; and means for transmitting, to a second sidelink device, sidelink control information (SCI) comprising a sidelink allocation indicating a set of sidelink resources from the one or more sidelink resource pools and indicating one or more sidelink sensing resources associated with the set of sidelink resources.

Clause 66. The first sidelink device of clause 65, wherein the one or more sidelink resource pools comprise a sidelink sensing resource pool or a joint sidelink communication and sensing resource pool.

Clause 67. The first sidelink device of any of clauses 65 to 66, further comprising: means for receiving, from a network entity, an indication that a last symbol of a sidelink slot is configured to be reserved by the first sidelink device as the one or more sidelink sensing resources.

Clause 68. The first sidelink device of any of clauses 65 to 67, further comprising: means for determining that the one or more sidelink sensing resources are to be used for bistatic sensing; and means for formatting, based at least in part on the determining, the SCI format to include control information of a sensing waveform associated with the one or more sidelink sensing resources.

Clause 69. The first sidelink device of any of clauses 65 to 68, wherein the sidelink allocation indicates one or more sidelink communication resources associated with the set of sidelink resources.

Clause 70. The first sidelink device of clause 69, wherein: the SCI comprises a semi-persistent scheduling of the one or more sidelink communication resources and a semi-persistent scheduling of the one or more sidelink communication resources; or the SCI comprises a dynamic scheduling of the one or more sidelink communication resources and the semi-persistent scheduling of the one or more sidelink communication resources.

Clause 71. The first sidelink device of any of clauses 66 to 70, wherein the SCI comprises an indication of a sensing procedure associated with the one or more sidelink sensing resources.

Clause 72. The first sidelink device of any of clauses 66 to 71, further comprising: means for performing a monostatic sensing procedure; and means for transmitting, to a network entity, a report associated with the monostatic sensing procedure.

Clause 73. The first sidelink device of any of clauses 66 to 72, further comprising: means for performing a bistatic sensing procedure cooperative with the second sidelink device, and wherein the SCI comprises an indication for the second sidelink device to transmit a report associated with the bistatic sensing procedure to at least one of a network entity or the first sidelink device.

Clause 74. The first sidelink device of any of clauses 66 to 73, further comprising: means for performing a monostatic sensing procedure and a bistatic sensing procedure cooperative with the second sidelink device.

Clause 75. The first sidelink device of clause 74, wherein the SCI comprises an indication for the second sidelink device to transmit a first report associated with the bistatic sensing procedure to the first sidelink device, and the method further comprising: means for receiving the first report associated with the bistatic sensing procedure; means for combining a second report associated with the monostatic sensing procedure with the first report associated with the bistatic sensing procedure; and means for transmitting, to a network entity, a combined report associated with the monostatic sensing procedure and the bistatic sensing procedure.

Clause 76. The first sidelink device of any of clauses 74 to 75, further comprising: means for transmitting a report associated with the monostatic sensing procedure to the second sidelink device, and wherein the SCI comprises an indication for the second sidelink device to transmit a combined report associated with the monostatic sensing procedure and the bistatic sensing procedure.

Clause 77. A first sidelink device, comprising: means for receiving a configuration indicating one or more sidelink resource pools; means for receiving, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and means for processing the SCI based at least in part on a radio frequency (RF) capability type of the first sidelink device.

Clause 78. The first sidelink device of clause 77, wherein the sidelink allocation comprises the one or more sidelink sensing resources, and the method further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink sensing resources.

Clause 79. The first sidelink device of any of clauses 77 to 78, wherein the sidelink allocation comprises the one or more sidelink communication resources.

Clause 80. The first sidelink device of clause 79, further comprising: means for refraining, based at least in part on the RF capability type of the first sidelink device being a sensing-only type, from transmitting SCI for reserving sidelink sensing resources in the set of sidelink resources; and means for refraining, based at least in part on the RF capability type of the first sidelink device being the sensing-only type, from monitoring signals corresponding to the one or more sidelink communication resources.

Clause 81. The first sidelink device of any of clauses 79 to 80, further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink communication resources.

Clause 82. The first sidelink device of any of clauses 77 to 81, wherein the sidelink allocation comprises the one or more sidelink communication resources and the one or more sidelink sensing resources, and the method further comprising: refraining, based at least in part on the RF capability type of the first sidelink device being a joint communication and sensing type, from transmitting SCI for reserving sidelink resources in the set of sidelink resources; monitoring, via a first set of RF components and based at least in part on the RF capability type of the first sidelink device being the joint communication and sensing type, signals corresponding to the one or more sidelink communication resources; and monitoring, via a second set of RF components different from the first set of RF components and based at least in part on the RF capability type of the first sidelink device being the joint communication and sensing type, signals corresponding to the one or more sidelink sensing resources.

Clause 83. The first sidelink device of any of clauses 77 to 82, wherein: the SCI comprises a first indication of a bistatic sensing procedure associated with the one or more sidelink sensing resources; and the SCI comprises a second indication for the first sidelink device to transmit a report associated with the bistatic sensing procedure to at least one of a network entity or the second sidelink device, and the method further comprising: means for performing, based at least in part on the first indication in the SCI, the bistatic sensing procedure cooperative with the second sidelink device; and means for transmitting, based at least in part on the second indication in the SCI, the report associated with the bistatic sensing procedure.

Clause 84. The first sidelink device of clause 83, wherein: the SCI comprises a first indication of a monostatic sensing procedure and a bistatic sensing procedure associated with the one or more sidelink sensing resources; and the SCI comprises a second indication for the first sidelink device to transmit a combined report associated with the monostatic sensing procedure and the bistatic sensing procedure, and the method further comprising: means for performing, based at least in part on the first indication in the SCI, the bistatic sensing procedure cooperative with the second sidelink device; means for receiving, from the second sidelink device, a report associated with the monostatic sensing procedure; means for combining the report associated with the monostatic sensing procedure and a report associated with the bistatic sensing procedure; and means for transmitting, based at least in part on the second indication in the SCI, the combined report associated with the monostatic sensing procedure and the bistatic sensing procedure.

Clause 85. A non-transitory computer-readable medium storing computer-executable instructions that, when executed by a sidelink device, cause the sidelink device to: receive a configuration indicating one or more sidelink resource pools; receive a request to report a radio frequency (RF) capability; transmit, responsive to the request, an RF capability type of the sidelink device; and receive a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

Clause 86. The non-transitory computer-readable medium of clause 85, wherein the sidelink allocation comprises the one or more sidelink communication resources absent any indication of a sidelink sensing resource based at least in part on the RF capability type of the sidelink device being a communication-only type.

Clause 87. The non-transitory computer-readable medium of any of clauses 85 to 86, wherein: the sidelink allocation comprises the one or more sidelink sensing resources absent any indication of a sidelink communication resource based at least in part on the RF capability type of the sidelink device being a sensing-only type; and the one or more sidelink sensing resources comprise a last symbol of sidelink slot.

Clause 88. The non-transitory computer-readable medium of any of clauses 85 to 87, wherein: the sidelink allocation comprises the one or more sidelink communication resources and the one or more sidelink sensing resources based at least in part on the RF capability type of the sidelink device being a joint communication and sensing type; and the one or more sidelink sensing resources comprise one or more guard periods associated with the one or more sidelink communication resources.

Clause 89. The non-transitory computer-readable medium of clause 88, further comprising computer-executable instructions that, when executed by the sidelink device, cause the sidelink device to: transmit a communication scheduling request and a sensing scheduling request in a first uplink control information (UCI) via a first physical uplink control channel (PUCCH).

Clause 90. The non-transitory computer-readable medium of any of clauses 88 to 89, further comprising computer-executable instructions that, when executed by the sidelink device, cause the sidelink device to: encode a communication scheduling request in a first uplink control information (UCI); encode a sensing scheduling request in a second UCI different from the first UCI; transmit the first UCI via a first physical uplink control channel (PUCCH); and transmit the second UCI via a second PUCCH.

Clause 91. The non-transitory computer-readable medium of clause 90, wherein the sidelink allocation is received as a downlink control information (DCI) via a physical downlink control channel (PDCCH).

Clause 92. The non-transitory computer-readable medium of any of clauses 90 to 91, wherein the sidelink allocation is received as a first downlink control information (DCI) via a first physical downlink control channel (PDCCH) and a second DCI via a second PDCCH different from the first PDCCH.

Clause 93. A non-transitory computer-readable medium storing computer-executable instructions that, when executed by a first sidelink device, cause the first sidelink device to: receive a configuration indicating one or more sidelink resource pools; and transmit, to a second sidelink device, sidelink control information (SCI) comprising a sidelink allocation indicating a set of sidelink resources from the one or more sidelink resource pools and indicating one or more sidelink sensing resources associated with the set of sidelink resources.

Clause 94. The non-transitory computer-readable medium of clause 93, wherein the one or more sidelink resource pools comprise a sidelink sensing resource pool or a joint sidelink communication and sensing resource pool.

Clause 95. The non-transitory computer-readable medium of any of clauses 93 to 94, further comprising computer-executable instructions that, when executed by the first sidelink device, cause the first sidelink device to: receive, from a network entity, an indication that a last symbol of a sidelink slot is configured to be reserved by the first sidelink device as the one or more sidelink sensing resources.

Clause 96. The non-transitory computer-readable medium of any of clauses 93 to 95, further comprising computer-executable instructions that, when executed by the first sidelink device, cause the first sidelink device to: determine that the one or more sidelink sensing resources are to be used for bistatic sensing; and format, based at least in part on the determining, the SCI format to include control information of a sensing waveform associated with the one or more sidelink sensing resources.

Clause 97. The non-transitory computer-readable medium of any of clauses 93 to 96, wherein the sidelink allocation indicates one or more sidelink communication resources associated with the set of sidelink resources.

Clause 98. The non-transitory computer-readable medium of clause 97, wherein: the SCI comprises a semi-persistent scheduling of the one or more sidelink communication resources and a semi-persistent scheduling of the one or more sidelink communication resources; or the SCI comprises a dynamic scheduling of the one or more sidelink communication resources and the semi-persistent scheduling of the one or more sidelink communication resources.

Clause 99. The non-transitory computer-readable medium of any of clauses 94 to 98, wherein the SCI comprises an indication of a sensing procedure associated with the one or more sidelink sensing resources.

Clause 100. The non-transitory computer-readable medium of any of clauses 94 to 99, further comprising computer-executable instructions that, when executed by the first sidelink device, cause the first sidelink device to: perform a monostatic sensing procedure; and transmit, to a network entity, a report associated with the monostatic sensing procedure.

Clause 101. The non-transitory computer-readable medium of any of clauses 94 to 100, further comprising computer-executable instructions that, when executed by the first sidelink device, cause the first sidelink device to: perform a bistatic sensing procedure cooperative with the second sidelink device, and wherein the SCI comprises an indication for the second sidelink device to transmit a report associated with the bistatic sensing procedure to at least one of a network entity or the first sidelink device.

Clause 102. The non-transitory computer-readable medium of any of clauses 94 to 101, further comprising computer-executable instructions that, when executed by the first sidelink device, cause the first sidelink device to: perform a monostatic sensing procedure and a bistatic sensing procedure cooperative with the second sidelink device.

Clause 103. The non-transitory computer-readable medium of any of clauses 101 to 102, wherein the SCI comprises an indication for the second sidelink device to transmit a first report associated with the bistatic sensing procedure to the first sidelink device, and the method further comprising: receive the first report associated with the bistatic sensing procedure; combine a second report associated with the monostatic sensing procedure with the first report associated with the bistatic sensing procedure; and transmit, to a network entity, a combined report associated with the monostatic sensing procedure and the bistatic sensing procedure.

Clause 104. The non-transitory computer-readable medium of any of clauses 101 to 103, further comprising computer-executable instructions that, when executed by the first sidelink device, cause the first sidelink device to: transmit a report associated with the monostatic sensing procedure to the second sidelink device, and wherein the SCI comprises an indication for the second sidelink device to transmit a combined report associated with the monostatic sensing procedure and the bistatic sensing procedure.

Clause 105. A non-transitory computer-readable medium storing computer-executable instructions that, when executed by a first sidelink device, cause the first sidelink device to: receive a configuration indicating one or more sidelink resource pools; receive, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and process the SCI based at least in part on a radio frequency (RF) capability type of the first sidelink device.

Clause 106. The non-transitory computer-readable medium of any of clauses 104 to 105, wherein the sidelink allocation comprises the one or more sidelink sensing resources, and the method further comprising: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink sensing resources.

Clause 107. The non-transitory computer-readable medium of any of clauses 104 to 106, wherein the sidelink allocation comprises the one or more sidelink communication resources.

Clause 108. The non-transitory computer-readable medium of any of clauses 106 to 107, further comprising computer-executable instructions that, when executed by the first sidelink device, cause the first sidelink device to: refrain, based at least in part on the RF capability type of the first sidelink device being a sensing-only type, from transmitting SCI for reserving sidelink sensing resources in the set of sidelink resources; and refrain, based at least in part on the RF capability type of the first sidelink device being the sensing-only type, from monitoring signals corresponding to the one or more sidelink communication resources.

Clause 109. The non-transitory computer-readable medium of any of clauses 106 to 108, further comprising computer-executable instructions that, when executed by the first sidelink device, cause the first sidelink device to: refraining, based at least in part on the RF capability type of the first sidelink device being a joint communication and sensing type, from transmitting SCI for reserving sidelink resources in the set of sidelink resources; and monitoring, based at least in part on the RF capability type of the first sidelink device being the joint communication and sensing type, signals corresponding to the one or more sidelink communication resources.

Clause 110. The non-transitory computer-readable medium of any of clauses 104 to 109, wherein the sidelink allocation comprises the one or more sidelink communication resources and the one or more sidelink sensing resources, and the method further comprising: refraining, based at least in part on the RF capability type of the first sidelink device being a joint communication and sensing type, from transmitting SCI for reserving sidelink resources in the set of sidelink resources; monitoring, via a first set of RF components and based at least in part on the RF capability type of the first sidelink device being the joint communication and sensing type, signals corresponding to the one or more sidelink communication resources; and monitoring, via a second set of RF components different from the first set of RF components and based at least in part on the RF capability type of the first sidelink device being the joint communication and sensing type, signals corresponding to the one or more sidelink sensing resources.

Clause 111. The non-transitory computer-readable medium of any of clauses 104 to 110, wherein: the SCI comprises a first indication of a bistatic sensing procedure associated with the one or more sidelink sensing resources; and the SCI comprises a second indication for the first sidelink device to transmit a report associated with the bistatic sensing procedure to at least one of a network entity or the second sidelink device, and the method further comprising: perform, based at least in part on the first indication in the SCI, the bistatic sensing procedure cooperative with the second sidelink device; and transmit, based at least in part on the second indication in the SCI, the report associated with the bistatic sensing procedure.

Clause 112. The non-transitory computer-readable medium of any of clauses 110 to 111, wherein: the SCI comprises a first indication of a monostatic sensing procedure and a bistatic sensing procedure associated with the one or more sidelink sensing resources; and the SCI comprises a second indication for the first sidelink device to transmit a combined report associated with the monostatic sensing procedure and the bistatic sensing procedure, and the method further comprising: perform, based at least in part on the first indication in the SCI, the bistatic sensing procedure cooperative with the second sidelink device; receive, from the second sidelink device, a report associated with the monostatic sensing procedure; combine the report associated with the monostatic sensing procedure and a report associated with the bistatic sensing procedure; and transmit, based at least in part on the second indication in the SCI, the combined report associated with the monostatic sensing procedure and the bistatic sensing procedure.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a sidelink device, comprising:
receiving a configuration indicating one or more sidelink resource pools;
receiving a request to report a radio frequency (RF) capability;
transmitting, responsive to the request, an RF capability type of the sidelink device; and
receiving a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

2. The method of claim 1, wherein the sidelink allocation comprises the one or more sidelink communication resources absent any indication of a sidelink sensing resource based at least in part on the RF capability type of the sidelink device being a communication-only type.

3. The method of claim 1, wherein:
the sidelink allocation comprises the one or more sidelink sensing resources absent any indication of a sidelink communication resource based at least in part on the RF capability type of the sidelink device being a sensing-only type; and
the one or more sidelink sensing resources comprise a last symbol of sidelink slot.

4. The method of claim 1, wherein:
the sidelink allocation comprises the one or more sidelink communication resources and the one or more sidelink sensing resources based at least in part on the RF capability type of the sidelink device being a joint communication and sensing type; and
the one or more sidelink sensing resources comprise one or more guard periods associated with the one or more sidelink communication resources.

5. The method of claim 4, further comprising:
transmitting a communication scheduling request and a sensing scheduling request in a first uplink control information (UCI) via a first physical uplink control channel (PUCCH).

6. The method of claim 4, further comprising:
encoding a communication scheduling request in a first uplink control information (UCI);
encoding a sensing scheduling request in a second UCI different from the first UCI;
transmitting the first UCI via a first physical uplink control channel (PUCCH); and
transmitting the second UCI via a second PUCCH.

7. The method of claim 6, wherein the sidelink allocation is received as a downlink control information (DCI) via a physical downlink control channel (PDCCH).

8. The method of claim 6, wherein the sidelink allocation is received as a first downlink control information (DCI) via a first physical downlink control channel (PDCCH) and a second DCI via a second PDCCH different from the first PDCCH.

9. A method of wireless communication performed by a first sidelink device, comprising:
receiving a configuration indicating one or more sidelink resource pools; and
transmitting, to a second sidelink device, sidelink control information (SCI) comprising a sidelink allocation indicating a set of sidelink resources from the one or more sidelink resource pools and indicating one or more sidelink sensing resources associated with the set of sidelink resources.

10. The method of claim 9, wherein the one or more sidelink resource pools comprise a sidelink sensing resource pool or a joint sidelink communication and sensing resource pool.

11. The method of claim 9, further comprising:
receiving, from a network entity, an indication that a last symbol of a sidelink slot is configured to be reserved by the first sidelink device as the one or more sidelink sensing resources.

12. The method of claim 9, further comprising:
determining that the one or more sidelink sensing resources are to be used for bistatic sensing; and
formatting, based at least in part on the determining, the SCI format to include control information of a sensing waveform associated with the one or more sidelink sensing resources.

13. The method of claim 9, wherein the sidelink allocation indicates one or more sidelink communication resources associated with the set of sidelink resources.

14. The method of claim 13, wherein:
the SCI comprises a semi-persistent scheduling of the one or more sidelink communication resources and a semi-persistent scheduling of the one or more sidelink communication resources; or
the SCI comprises a dynamic scheduling of the one or more sidelink communication resources and the semi-persistent scheduling of the one or more sidelink communication resources.

15. The method of claim 10, wherein the SCI comprises an indication of a sensing procedure associated with the one or more sidelink sensing resources.

16. The method of claim 10, further comprising:
performing a monostatic sensing procedure; and
transmitting, to a network entity, a report associated with the monostatic sensing procedure.

17. The method of claim 10, further comprising:
performing a bistatic sensing procedure cooperative with the second sidelink device, and wherein the SCI comprises an indication for the second sidelink device to transmit a report associated with the bistatic sensing procedure to at least one of a network entity or the first sidelink device.

18. The method of claim 10, further comprising:
performing a monostatic sensing procedure and a bistatic sensing procedure cooperative with the second sidelink device.

19. The method of claim 18, wherein the SCI comprises an indication for the second sidelink device to transmit a first report associated with the bistatic sensing procedure to the first sidelink device, and the method further comprising:
receiving the first report associated with the bistatic sensing procedure;
combining a second report associated with the monostatic sensing procedure with the first report associated with the bistatic sensing procedure; and
transmitting, to a network entity, a combined report associated with the monostatic sensing procedure and the bistatic sensing procedure.

20. The method of claim 18, further comprising:
transmitting a report associated with the monostatic sensing procedure to the second sidelink device, and wherein the SCI comprises an indication for the second sidelink device to transmit a combined report associated with the monostatic sensing procedure and the bistatic sensing procedure.

21. A method of wireless communication performed by a first sidelink device, comprising:
receiving a configuration indicating one or more sidelink resource pools;
receiving, from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and
processing the SCI based at least in part on a radio frequency (RF) capability type of the first sidelink device.

22. The method of claim 21, wherein the sidelink allocation comprises the one or more sidelink sensing resources, and the method further comprising:
refraining, based at least in part on the RF capability type of the first sidelink device being a joint communication and sensing type, from transmitting SCI for reserving sidelink resources in the set of sidelink resources; and
monitoring, based at least in part on the RF capability type of the first sidelink device being the joint communication and sensing type, signals corresponding to the one or more sidelink sensing resources.

23. The method of claim 21, wherein the sidelink allocation comprises the one or more sidelink communication resources.

24. The method of claim 23, further comprising:
refraining, based at least in part on the RF capability type of the first sidelink device being a sensing-only type, from transmitting SCI for reserving sidelink sensing resources in the set of sidelink resources; and
refraining, based at least in part on the RF capability type of the first sidelink device being the sensing-only type, from monitoring signals corresponding to the one or more sidelink communication resources.

25. The method of claim 23, further comprising:
refraining, based at least in part on the RF capability type of the first sidelink device being a joint communication and sensing type, from transmitting SCI for reserving sidelink resources in the set of sidelink resources; and
monitoring, based at least in part on the RF capability type of the first sidelink device being the joint communication and sensing type, signals corresponding to the one or more sidelink communication resources.

26. The method of claim 21, wherein the sidelink allocation comprises the one or more sidelink communication resources and the one or more sidelink sensing resources, and the method further comprising:
refraining, based at least in part on the RF capability type of the first sidelink device being a joint communication and sensing type, from transmitting SCI for reserving sidelink resources in the set of sidelink resources;
monitoring, via a first set of RF components and based at least in part on the RF capability type of the first sidelink device being the joint communication and sensing type, signals corresponding to the one or more sidelink communication resources; and
monitoring, via a second set of RF components different from the first set of RF components and based at least in part on the RF capability type of the first sidelink device being the joint communication and sensing type, signals corresponding to the one or more sidelink sensing resources.

27. The method of claim 21, wherein:
the SCI comprises a first indication of a bistatic sensing procedure associated with the one or more sidelink sensing resources; and
the SCI comprises a second indication for the first sidelink device to transmit a report associated with the bistatic sensing procedure to at least one of a network entity or the second sidelink device, and the method further comprising:
performing, based at least in part on the first indication in the SCI, the bistatic sensing procedure cooperative with the second sidelink device; and
transmitting, based at least in part on the second indication in the SCI, the report associated with the bistatic sensing procedure.

28. The method of claim 27, wherein:
the SCI comprises a first indication of a monostatic sensing procedure and a bistatic sensing procedure associated with the one or more sidelink sensing resources; and
the SCI comprises a second indication for the first sidelink device to transmit a combined report associated with the monostatic sensing procedure and the bistatic sensing procedure, and the method further comprising:
performing, based at least in part on the first indication in the SCI, the bistatic sensing procedure cooperative with the second sidelink device;
receiving, from the second sidelink device, a report associated with the monostatic sensing procedure;
combining the report associated with the monostatic sensing procedure and a report associated with the bistatic sensing procedure; and
transmitting, based at least in part on the second indication in the SCI, the combined report associated with the monostatic sensing procedure and the bistatic sensing procedure.

29. A sidelink device, comprising:
one or more memories;
one or more transceivers; and
one or more processors communicatively coupled to the one or more memories and the one or more transceivers, the one or more processors, either alone or in combination, configured to:
receive, via the one or more transceivers, a configuration indicating one or more sidelink resource pools;
receive, via the one or more transceivers, a request to report a radio frequency (RF) capability;
transmit, via the one or more transceivers, responsive to the request, an RF capability type of the sidelink device; and
receive, via the one or more transceivers, a sidelink allocation indicating a set of sidelink resources from the one or more sidelink resource pools and indicating one or more sidelink communication resources, one or more sidelink sensing resources, or both associated with the set of sidelink resources, wherein the sidelink allocation is based at least in part on the RF capability type of the sidelink device.

30. The sidelink device of claim 29, wherein the sidelink allocation comprises the one or more sidelink communication resources absent any indication of a sidelink sensing resource based at least in part on the RF capability type of the sidelink device being a communication-only type.

31. A first sidelink device, comprising:
one or more memories;
one or more transceivers; and
one or more processors communicatively coupled to the one or more memories and the one or more transceivers, the one or more processors, either alone or in combination, configured to:
receive, via the one or more transceivers, a configuration indicating one or more sidelink resource pools; and
transmit, via the one or more transceivers and to a second sidelink device, sidelink control information (SCI) comprising a sidelink allocation indicating a set of sidelink resources from the one or more sidelink resource pools and indicating one or more sidelink sensing resources associated with the set of sidelink resources.

32. A first sidelink device, comprising:
one or more memories;
one or more transceivers; and
one or more processors communicatively coupled to the one or more memories and the one or more transceivers, the one or more processors, either alone or in combination, configured to:
receive, via the one or more transceivers, a configuration indicating one or more sidelink resource pools;
receive, via the one or more transceivers and from a second sidelink device, sidelink control information (SCI) comprising a sidelink allocation indicating a set of sidelink resources from the one or more sidelink resource pools and indicating one or more sidelink communication resources, one or more sidelink sensing resources, or both associated with the set of sidelink resources; and
process the SCI based at least in part on a radio frequency (RF) capability type of the first sidelink device.
